(19) United States
(12) Patent Application Publication
(10) Pub. No.: US 2023/0345253 A1
(43) Pub. Date: Oct. 26, 2023

(54) RADIO ACCESS TECHNOLOGY SPECTRUM SHARING

(71) Applicant: QUALCOMM Incorporated, San Diego, CA (US)

(72) Inventors: Jing LEI, San Diego, CA (US); Krishna Kiran MUKKAVILLI, San Diego, CA (US); Tingfang JI, San Diego, CA (US)

(21) Appl. No.: 17/660,294

(22) Filed: Apr. 22, 2022

(51) Int. Cl. H04W 16/14; H04W 72/04; H04L 5/14; H04L 1/00; H04L 27/26

(52) U.S. Cl. CPC H04W 16/14; H04W 72/044; H04W 72/042; H04L 5/14; H04L 1/0067; H04L 27/2607

(57) ABSTRACT

Various aspects of the present disclosure generally relate to wireless communication. In some aspects, a user equipment (UE) may transmit an uplink (UL) channel of a first radio access technology (RAT) in a first set of radio resources mapped to an UL carrier or a downlink (DL) carrier for a second RAT, where the UL carrier or the DL carrier for the second RAT is used for UL transmission or DL reception of the second RAT in frequency division duplex operation. The UE may receive a DL channel of the first RAT in a second set of radio resources mapped to the UL carrier or the DL carrier for the second RAT. Numerous other aspects are described.

### FIELD OF THE DISCLOSURE

Aspects of the present disclosure generally relate to wireless communication and to techniques and apparatuses for spectrum sharing with multiple radio access technologies.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting an uplink (UL) channel of a first radio access technology (RAT) in a first set of radio resources mapped to an UL carrier for a second RAT, where the UL carrier for the second RAT is used for UL transmission of the second RAT in frequency division duplex (FDD) operation. The method may include receiving a downlink (DL) channel of the first RAT in a second set of radio resources mapped to the UL carrier for the second RAT.

Some aspects described herein relate to a method of wireless communication performed by a UE. The method may include transmitting an UL channel of a first RAT in a first set of radio resources mapped to a DL carrier for a second RAT, where the DL carrier for the second RAT is used for DL reception of the second RAT in FDD operation. The method may include receiving a DL channel of the first RAT in a second set of radio resources mapped to the DL carrier for the second RAT.

Some aspects described herein relate to a method of wireless communication performed by a UE. The method may include communicating using a first RAT on an UL channel or a DL channel in a first set of radio resources on an UL carrier or a DL carrier for a second RAT. The method may include multiplexing communications of the first RAT and communications of the second RAT on the UL carrier or the DL carrier for the second RAT using frequency division multiplexing (FDM), time division multiplexing (TDM), spatial division multiplexing (SDM), subband full duplexing, in-band full duplexing, or a combination thereof, where the first RAT is operating in half-duplex frequency division duplex (HD-FDD), full-duplex FDD (FD-FDD), time division duplex (TDD), subband FD (SBFD), in-band FD (IBFD), or a combination thereof, and the second RAT is operating in HD-FDD, FD-FDD, subband FDD, or a combination thereof.

Some aspects described herein relate to a method of wireless communication performed by a UE. The method may include receiving a configuration that reallocates, to a first RAT, UL resources or DL resources reserved for a second RAT on an UL carrier or a DL carrier for the second RAT. The method may include multiplexing, based at least in part on the configuration, communications of the first RAT and communications of the second RAT in a shared spectrum using FDM, TDM, SDM, subband full duplexing, in-band full duplexing, or a combination thereof.

Some aspects described herein relate to a method of wireless communication performed by a network entity. The method may include communicating using a first RAT on an UL channel or a DL channel in a first set of radio resources on an UL carrier or a DL carrier for a second RAT. The method may include multiplexing communications of the first RAT and communications of the second RAT on the UL carrier or the DL carrier for the second RAT using FDM, TDM, SDM, subband full duplexing, in-band full duplexing, or a combination thereof, where the first RAT is operating in HD-FDD, FD-FDD, TDD, subband FDD, in-band full duplex (IBFD), or a combination thereof, and the second RAT is operating in HD-FDD, FD-FDD, subband FDD, or a combination thereof.

Some aspects described herein relate to a UE for wireless communication. The UE may include a memory and one or more processors coupled to the memory. The one or more processors may be configured to transmit an UL channel of a first RAT in a first set of radio resources mapped to an UL carrier for a second RAT, where the UL carrier for the second RAT is used for UL transmission of the second RAT in FDD operation. The one or more processors may be configured to receive a DL channel of the first RAT in a second set of radio resources mapped to the UL carrier for the second RAT.

Some aspects described herein relate to a UE for wireless communication. The UE may include a memory and one or more processors coupled to the memory. The one or more processors may be configured to transmit an UL channel of a first RAT in a first set of radio resources mapped to a DL carrier for a second RAT, where the DL carrier for the second RAT is used for DL reception of the second RAT in FDD operation. The one or more processors may be configured to receive a DL channel of the first RAT in a second set of radio resources mapped to the DL carrier for the second RAT.

Some aspects described herein relate to a UE for wireless communication. The UE may include a memory and one or more processors coupled to the memory. The one or more processors may be configured to communicate using a first RAT on an UL channel or a DL channel in a first set of radio resources on an UL carrier or a DL carrier for a second RAT. The one or more processors may be configured to multiplex communications of the first RAT and communications of the second RAT on the UL carrier or the DL carrier for the second RAT using FDM, TDM, SDM, subband full duplexing, in-band full duplexing, or a combination thereof, where the first RAT is operating in HD-FDD, FD-FDD, TDD, subband FDD, IBFD, or a combination thereof, and the second RAT is operating in HD-FDD, FD-FDD, subband FDD, or a combination thereof.

Some aspects described herein relate to a UE for wireless communication. The UE may include a memory and one or more processors coupled to the memory. The one or more processors may be configured to receive a configuration that reallocates, to a first RAT, UL resources or DL resources reserved for a second RAT on an UL carrier or a DL carrier for the second RAT. The one or more processors may be configured to multiplex, based at least in part on the configuration, communications of the first RAT and communications of the second RAT in a shared spectrum using FDM, TDM, SDM, subband full duplexing, in-band full duplexing, or a combination thereof.

Some aspects described herein relate to a network entity for wireless communication. The network entity may include a memory and one or more processors coupled to the memory. The one or more processors may be configured to communicate using a first RAT on an UL channel or a DL channel in a first set of radio resources on an UL carrier or a DL carrier for a second RAT. The one or more processors may be configured to multiplex communications of the first RAT and communications of the second RAT on the UL carrier or the DL carrier for the second RAT using FDM, TDM, SDM, subband full duplexing, in-band full duplexing, or a combination thereof, where the first RAT is operating in HD-FDD, FD-FDD, TDD, subband FDD, IBFD, or a combination thereof, and the second RAT is operating in HD-FDD, FD-FDD, or a combination thereof.

Some aspects described herein relate to a non-transitory computer-readable medium that stores a set of instructions for wireless communication by a UE. The set of instructions, when executed by one or more processors of the UE, may cause the UE to transmit an UL channel of a first RAT in a first set of radio resources mapped to an UL carrier for a second RAT, where the UL carrier for the second RAT is used for UL transmission of the second RAT in FDD operation. The set of instructions, when executed by one or more processors of the UE, may cause the UE to receive a DL channel of the first RAT in a second set of radio resources mapped to the UL carrier for the second RAT.

Some aspects described herein relate to a non-transitory computer-readable medium that stores a set of instructions for wireless communication by a UE. The set of instructions, when executed by one or more processors of the UE, may cause the UE to transmit an UL channel of a first RAT in a first set of radio resources mapped to a DL carrier for a second RAT, where the DL carrier for the second RAT is used for DL reception of the second RAT in FDD operation. The set of instructions, when executed by one or more processors of the UE, may cause the UE to receive a DL channel of the first RAT in a second set of radio resources mapped to the DL carrier for the second RAT.

Some aspects described herein relate to a non-transitory computer-readable medium that stores a set of instructions for wireless communication by a UE. The set of instructions, when executed by one or more processors of the UE, may cause the UE to communicate using a first RAT on an UL channel or a DL channel in a first set of radio resources on an UL carrier or a DL carrier for a second RAT. The set of instructions, when executed by one or more processors of the UE, may cause the UE to multiplex communications of the first RAT and communications of the second RAT on the UL carrier or the DL carrier for the second RAT using FDM, TDM, SDM, subband full duplexing, in-band full duplexing, or a combination thereof, where the first RAT is operating in HD-FDD, FD-FDD, TDD, subband FDD, IBFD, or a combination thereof, and the second RAT is operating in HD-FDD, FD-FDD, subband FDD, or a combination thereof.

Some aspects described herein relate to a non-transitory computer-readable medium that stores a set of instructions for wireless communication by a UE. The set of instructions, when executed by one or more processors of the UE, may cause the UE to receive a configuration that reallocates, to a first RAT, UL resources or DL resources reserved for a second RAT on an UL carrier or a DL carrier for the second RAT. The set of instructions, when executed by one or more processors of the UE, may cause the UE to multiplex, based at least in part on the configuration, communications of the first RAT and communications of the second RAT in a shared spectrum using FDM, TDM, SDM, subband full duplexing, in-band full duplexing, or a combination thereof.

Some aspects described herein relate to a non-transitory computer-readable medium that stores a set of instructions for wireless communication by a network entity. The set of instructions, when executed by one or more processors of the network entity, may cause the network entity to communicate using a first RAT on an UL channel or a DL channel in a first set of radio resources on an UL carrier or a DL carrier for a second RAT. The set of instructions, when executed by one or more processors of the network entity, may cause the network entity to multiplex communications of the first RAT and communications of the second RAT on the UL carrier or the DL carrier for the second RAT using FDM, TDM, SDM, subband duplexing, in-band full duplexing, or a combination thereof, where the first RAT is operating in HD-FDD, FD-FDD, TDD, subband FDD, IBFD, or a combination thereof, and the second RAT is operating in HD-FDD, FD-FDD, subband FDD, or a combination thereof.

Some aspects described herein relate to an apparatus for wireless communication. The apparatus may include means for transmitting an UL channel of a first RAT in a first set of radio resources mapped to an UL carrier for a second RAT, where the UL carrier for the second RAT is used for UL transmission of the second RAT in FDD operation. The apparatus may include means for receiving a DL channel of the first RAT in a second set of radio resources mapped to the UL carrier for the second RAT.

Some aspects described herein relate to an apparatus for wireless communication. The apparatus may include means for transmitting an UL channel of a first RAT in a first set of radio resources mapped to a DL carrier for a second RAT, where the DL carrier for the second RAT is used for DL reception of the second RAT in FDD operation. The apparatus may include means for receiving a DL channel of the first RAT in a second set of radio resources mapped to the DL carrier for the second RAT.

Some aspects described herein relate to an apparatus for wireless communication. The apparatus may include means for communicating using a first RAT on an UL channel or a DL channel in a first set of radio resources on an UL carrier or a DL carrier for a second RAT. The apparatus may include means for multiplexing communications of the first RAT and communications of the second RAT on the UL carrier or the DL carrier for the second RAT using FDM, TDM, SDM, subband full duplexing, in-band full duplexing, or a combination thereof, where the first RAT is operating in HD-FDD, FD-FDD, TDD, subband FDD, IBFD, or a combination thereof, and the second RAT is operating in HD-FDD, FD-FDD, subband FDD, or a combination thereof.

Some aspects described herein relate to an apparatus for wireless communication. The apparatus may include means for receiving a configuration that reallocates, to a first RAT, UL resources or DL resources reserved for a second RAT on an UL carrier or a DL carrier for the second RAT. The apparatus may include means for multiplexing, based at least in part on the configuration, communications of the first RAT and communications of the second RAT in a shared spectrum using FDM, TDM, SDM, subband full duplexing, in-band full duplexing, or a combination thereof.

Some aspects described herein relate to an apparatus for wireless communication. The apparatus may include means for communicating using a first RAT on an UL channel or a DL channel in a first set of radio resources on an UL carrier or a DL carrier for a second RAT. The apparatus may include means for multiplexing communications of the first RAT and communications of the second RAT on the UL carrier or the DL carrier for the second RAT using FDM, TDM, SDM, subband full duplexing, in-band full duplexing, or a combination thereof, where the first RAT is operating in HD-FDD, FD-FDD, TDD, subband FDD, IBFD, or a combination thereof, and the second RAT is operating in HD-FDD, FD-FDD, subband FDD, or a combination thereof.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating examples of full-duplex communication in a wireless network, in accordance with the present disclosure.

FIG. 5 is a diagram illustrating an example of flexible duplex scenarios, in accordance with the present disclosure.

FIG. 6 is a diagram illustrating an example associated with multiple radio access technologies (RATs) sharing spectrum, in accordance with the present disclosure.

FIG. 7 is a diagram illustrating an example of multiple RATs sharing spectrum, in accordance with the present disclosure.

FIG. 8 is a diagram illustrating an example of multiple RATs sharing spectrum, in accordance with the present disclosure.

FIG. 9 is a diagram illustrating an example of multiple RATs sharing spectrum, in accordance with the present disclosure.

FIG. 10 is a diagram illustrating an example process performed, for example, by a UE, in accordance with the present disclosure.

FIG. 11 is a diagram illustrating an example process performed, for example, by a UE, in accordance with the present disclosure.

FIG. 12 is a diagram illustrating an example process performed, for example, by a UE, in accordance with the present disclosure.

FIG. 13 is a diagram illustrating an example process performed, for example, by a UE, in accordance with the present disclosure.

FIG. 14 is a diagram illustrating an example process performed, for example, by a network entity, in accordance with the present disclosure.

FIGS. 15-16 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

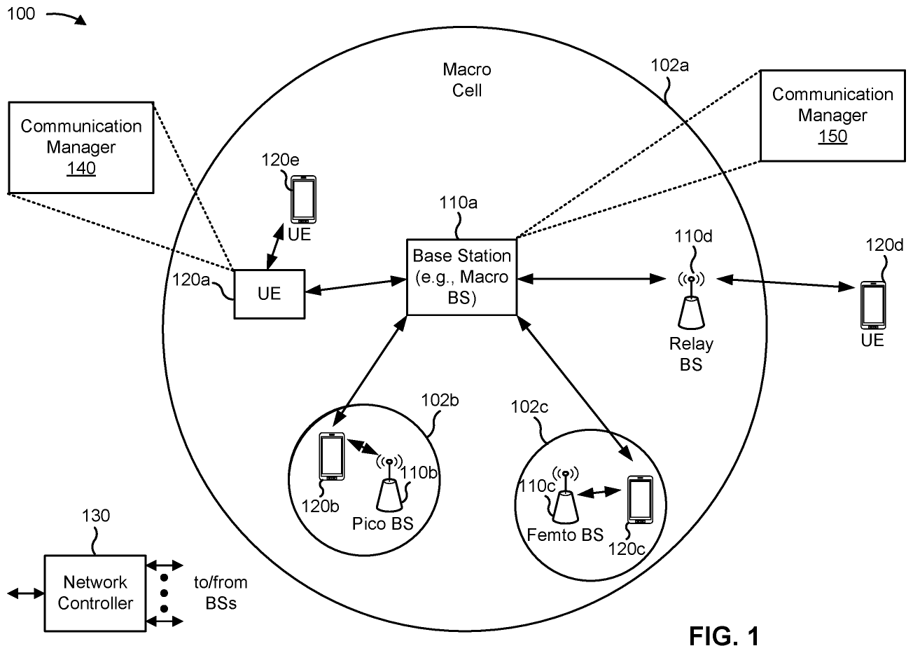

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may transmit an uplink (UL) channel of a first RAT in a first set of radio resources mapped to an UL carrier for a second RAT, where the UL carrier for the second RAT is used for UL transmission of the second RAT in frequency division duplex (FDD) operation. The communication manager 140 may receive a downlink (DL) channel of the first RAT in a second set of radio resources mapped to the UL carrier for the second RAT.

In some aspects, the communication manager 140 may transmit an UL channel of a first RAT in a first set of radio resources mapped to a DL carrier for a second RAT, where the DL carrier for the second RAT is used for DL reception of the second RAT in FDD operation. The communication manager 140 may receive a DL channel of the first RAT in a second set of radio resources mapped to the DL carrier for the second RAT.

In some aspects, the communication manager 140 may communicate using a first RAT on an UL channel or a DL channel in a first set of radio resources on an UL carrier or a DL carrier for a second RAT. The communication manager 140 may multiplex communications of the first RAT and communications of the second RAT on the UL carrier or the DL carrier for the second RAT using frequency division multiplexing (FDM), time division multiplexing (TDM), spatial division multiplexing (SDM), or a combination thereof, where the first RAT is operating in half-duplex frequency division duplex (HD-FDD), full-duplex FDD (FD-FDD), time division duplex (TDD), or a combination thereof, and the second RAT is operating in HD-FDD, FD-FDD, or a combination thereof.

In some aspects, the communication manager 140 may receive a configuration that reallocates, to a first RAT, UL resources or DL resources reserved for a second RAT on an UL carrier or a DL carrier for the second RAT. The communication manager 140 may multiplex, based at least in part on the configuration, communications of the first RAT and communications of the second RAT in a shared spectrum using FDM, TDM, SDM, or a combination thereof. Additionally, or alternatively, the communication manager 140 may perform one or more other operations described herein.

In some aspects, a network entity (e.g., base station 110) may include a communication manager 150. As described in more detail elsewhere herein, the communication manager 150 may communicate using a first RAT on an UL channel or a DL channel in a first set of radio resources on an UL carrier or a DL carrier for a second RAT. The communication manager 150 may multiplex communications of the first RAT and communications of the second RAT on the UL carrier or the DL carrier for the second RAT using FDM, TDM, SDM, or a combination thereof, where the first RAT is operating in HD-FDD, FD-FDD, TDD, or a combination thereof, and the second RAT is operating in HD-FDD, FD-FDD, or a combination thereof. Additionally, or alternatively, the communication manager 150 may perform one or more other operations described herein.

As indicated above, FIG. 1 is provided as an example. Other examples may differ from what is described with regard to FIG. 1.

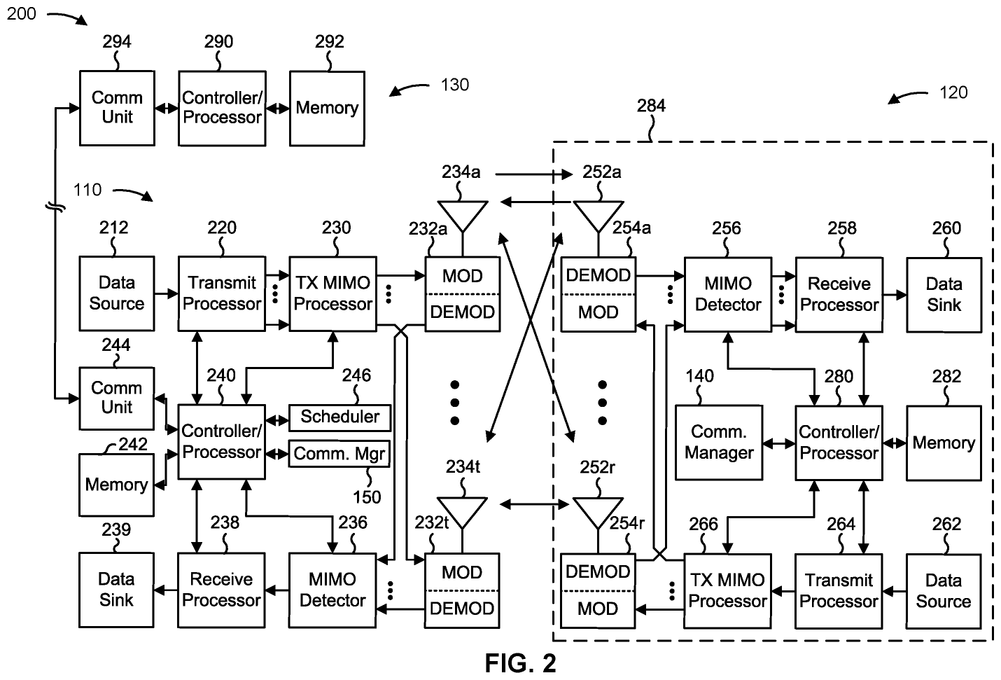

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

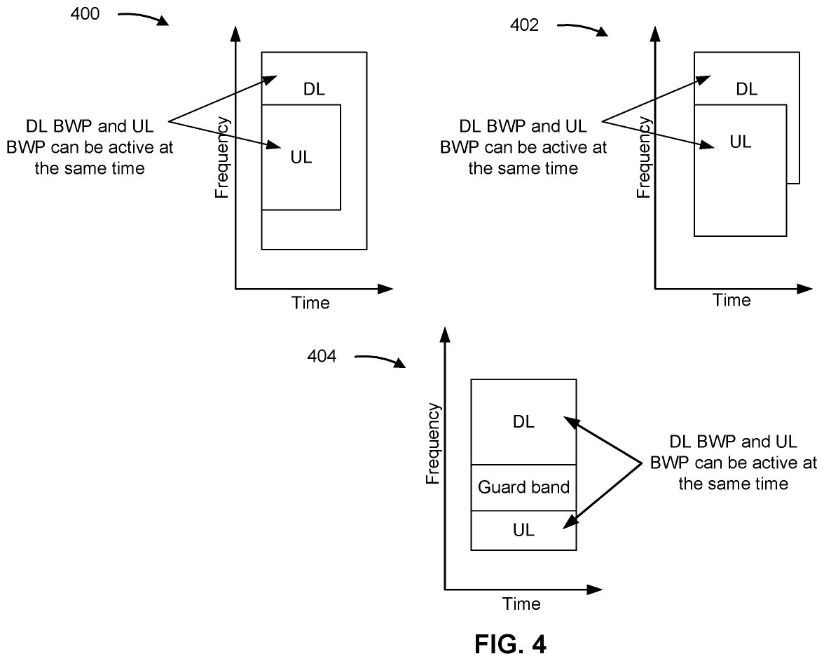

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-16).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-16).

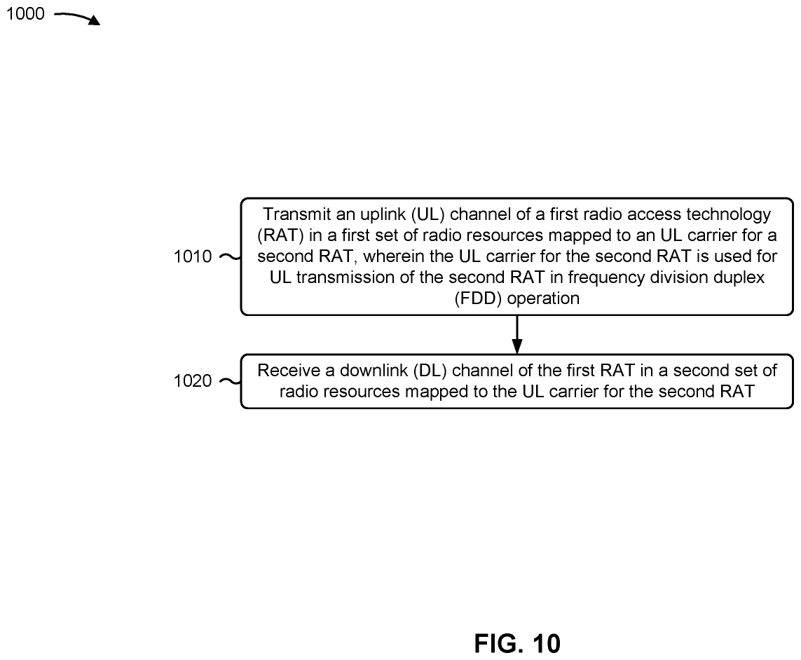

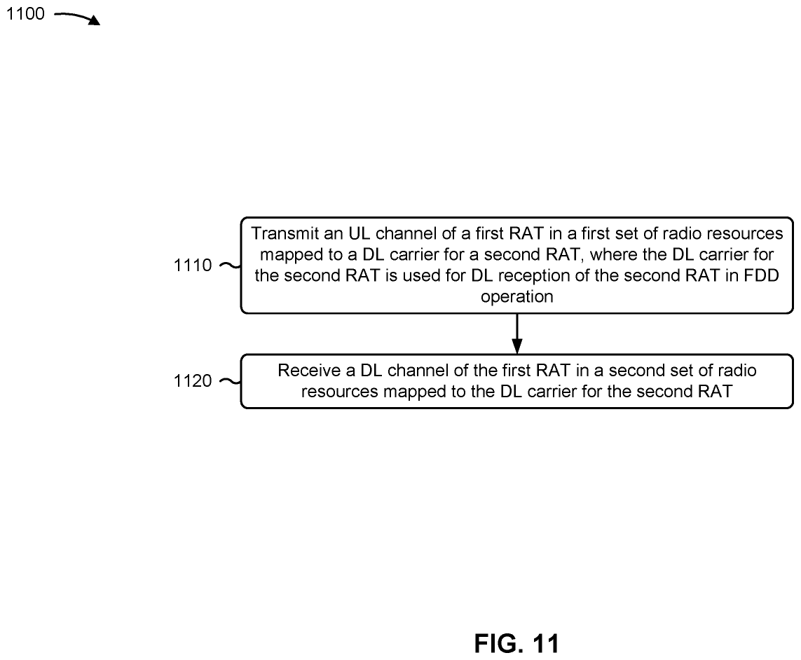

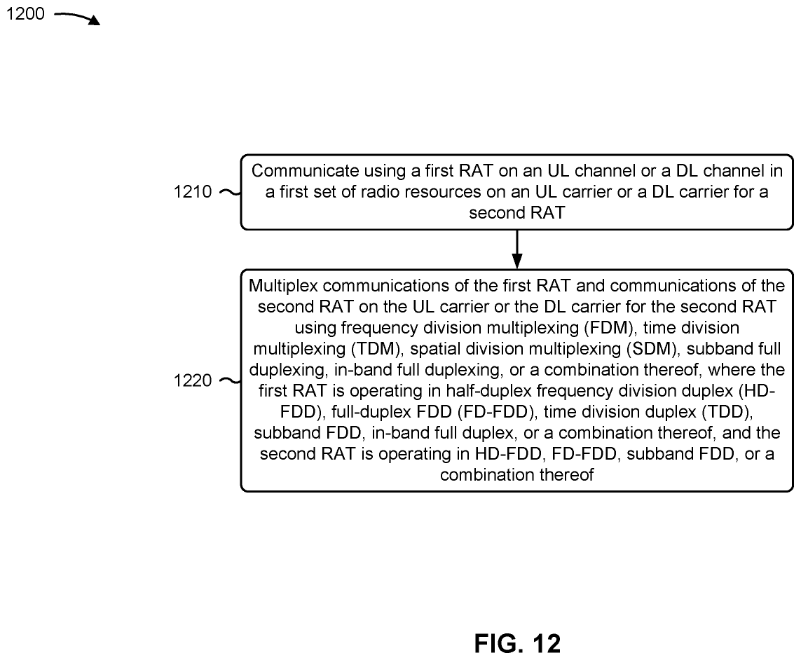

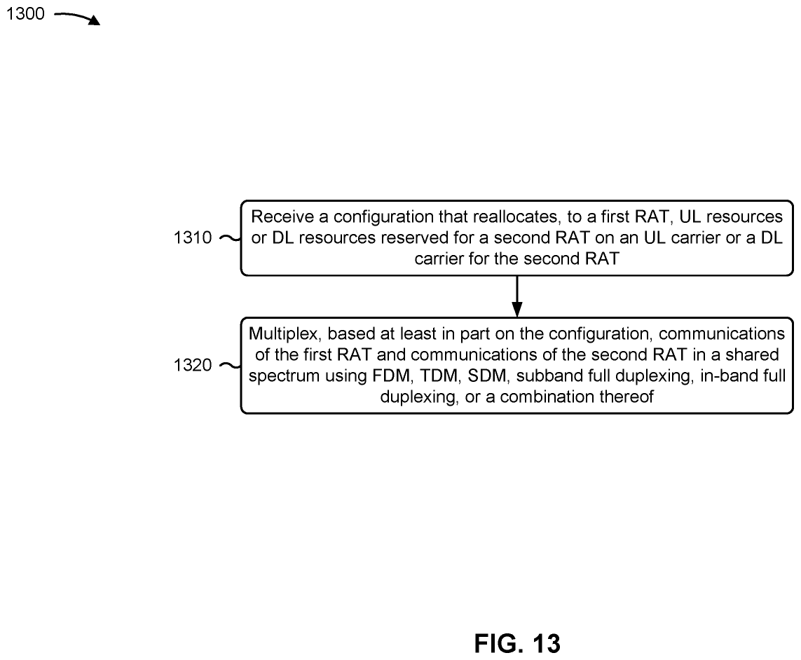

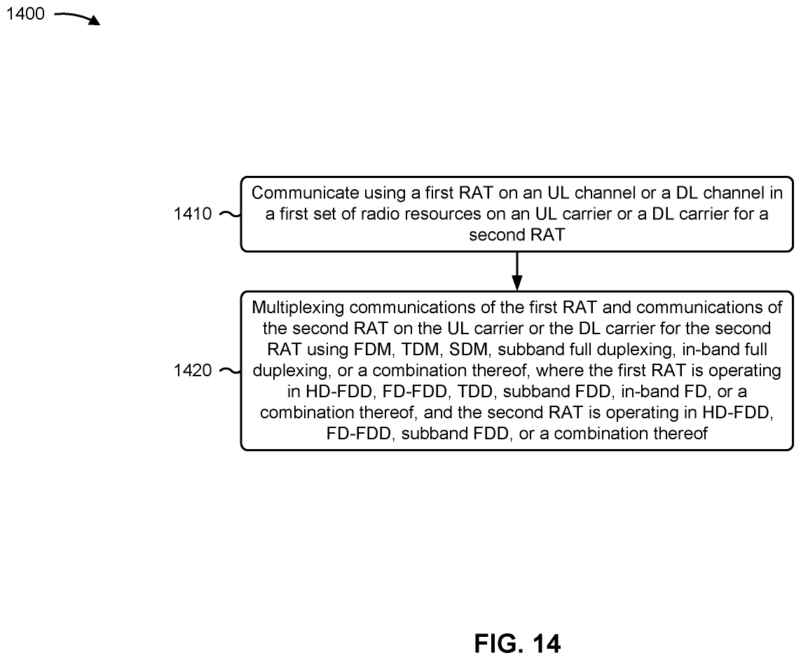

A controller/processor of a network entity, (e.g., the controller/processor 240 of the base station 110), the controller/processor 280 of the UE 120, and/or any other component(s) of FIG. 2 may perform one or more techniques associated with multiple RATs sharing a spectrum, as described in more detail elsewhere herein. For example, the controller/processor 240 of the base station 110, the controller/processor 280 of the UE 120, and/or any other component(s) of FIG. 2 may perform or direct operations of, for example, process 1000 of FIG. 10, process 1100 of FIG. 11, process 1200 of FIG. 12, process 1300 of FIG. 13, process 1400 of FIG. 14, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 1000 of FIG. 10, process 1100 of FIG. 11, process 1200 of FIG. 12, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE 120 includes means for transmitting an UL channel of a first RAT in a first set of radio resources mapped to an UL carrier for a second RAT, where the UL carrier for the second RAT is used for UL transmission of the second RAT in FDD operation; and/or means for receiving a DL channel of the first RAT in a second set of radio resources mapped to the UL carrier for the second RAT. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for transmitting an UL channel of a first RAT in a first set of radio resources mapped to a DL carrier for a second RAT, where the DL carrier for the second RAT is used for DL reception of the second RAT in FDD operation; and/or means for receiving a DL channel of the first RAT in a second set of radio resources mapped to the DL carrier for the second RAT.

In some aspects, the UE 120 includes means for communicating using a first RAT on an UL channel or a DL channel in a first set of radio resources on an UL carrier or a DL carrier for a second RAT; and/or means for multiplexing communications of the first RAT and communications of the second RAT on the UL carrier or the DL carrier for the second RAT using FDM, TDM, SDM, or a combination thereof, where the first RAT is operating in HD-FDD, FD-FDD, TDD, or a combination thereof, and the second RAT is operating in HD-FDD, FD-FDD, or a combination thereof.

In some aspects, the UE 120 includes means for receiving a configuration that reallocates, to a first RAT, UL resources or DL resources reserved for a second RAT on an UL carrier or a DL carrier for the second RAT; and/or means for multiplexing, based at least in part on the configuration, communications of the first RAT and communications of the second RAT in a shared spectrum using FDM, TDM, SDM, or a combination thereof.

In some aspects, a network entity (e.g., base station 110) includes means for communicating using a first RAT on an UL channel or a DL channel in a first set of radio resources on an UL carrier or a DL carrier for a second RAT; and/or means for multiplexing communications of the first RAT and communications of the second RAT on the UL carrier or the DL carrier for the second RAT using FDM, TDM, SDM, or a combination thereof, where the first RAT is operating in HD-FDD, FD-FDD, TDD, or a combination thereof, and the second RAT is operating in HD-FDD, FD-FDD, or a combination thereof. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

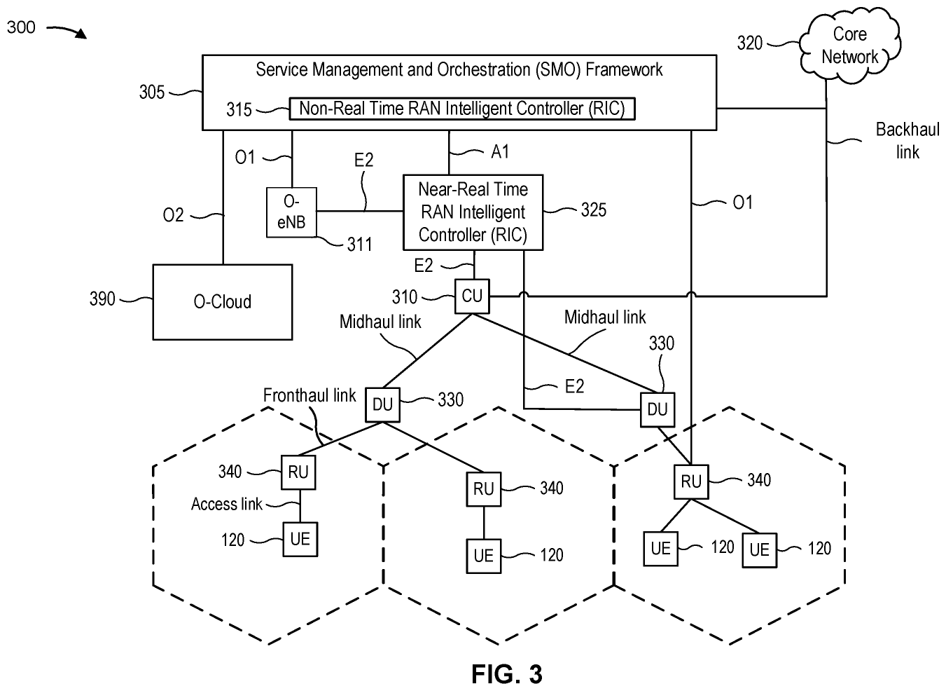

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)).

Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating examples 400, 402, and 404 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an UL communication and receive a DL communication at the same time (e.g., in the same slot or the same symbol). “Half-duplex communication” in a wireless network refers to unidirectional communications (e.g., only DL communication or only UL communication) between devices at a given time (e.g., in a given slot or a given symbol).

As shown in FIG. 4, examples 400 and 402 show examples of in-band full-duplex (IBFD) communication. In IBFD, a UE may transmit an UL communication to a base station and receive a DL communication from the base station on the same time and frequency resources. In-band full duplex (full duplexing) means the DL and the UL channels of the first RAT can be mapped to the overlapping radio resources, and the communications on the DL and the UL can happen concurrently. As shown in example 400, in a first example of IBFD, the time and frequency resources for UL communication may fully overlap with the time and frequency resources for DL communication. For example, the bandwidth part (BWP) for UL overlaps with the BWP for DL. As shown in example 402, in a second example of IBFD, the time and frequency resources for UL communication may partially overlap with the time and frequency resources for DL communication.

As further shown in FIG. 4, example 410 shows an example of subband full-duplex (SBFD) communication, which may also be referred to as “subband frequency division duplex (SBFDD)” or “flexible duplex.” In SBFD, a UE may transmit an UL communication to a base station and receive a DL communication from the base station at the same time, but on different frequency resources. For example, the different frequency resources may be subbands of a frequency band, such as a time division duplexing band. In this case, the frequency resources used for DL communication may be separated from the frequency resources used for UL communication, in the frequency domain, by a guard band.

As indicated above, FIG. 4 is provided as an example. Other examples may differ from what is described with respect to FIG. 4.

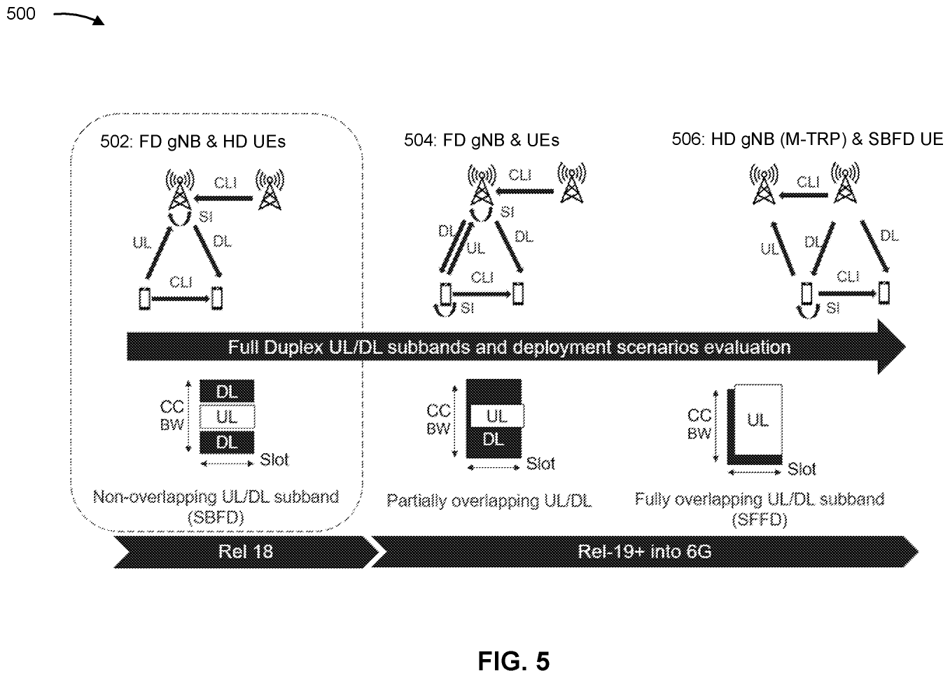

FIG. 5 is a diagram illustrating an example 500 of flexible duplex scenarios, in accordance with the present disclosure.

As shown by scenario 502, an NR network entity (e.g., gNB) may operate in a full duplex (FD) mode to serve UEs that may operate in a half-duplex (HD) mode. As there are multiple links and UEs, the UEs may experience self-interference (SI) or cross-link interference (CLI) from other UEs.

Time-division duplex (TDD) involves separating resources based on time. Different resources may be used in each slot, time interval, or symbol. Subbands used with TDD may be referred to as “TDD subbands.” The NR network entity may use SBFD for some TDD subbands to improve throughput, latency, and uplink coverage for the UEs (as part of 3GPP NR standards Release 18). Scenario 502 shows that subbands used for DL are different than a subband used for UL.

Scenario 504 shows UL and DL bandwidths that partially overlap. Scenario 506 shows UL and DL bandwidths that fully overlap. Scenario 506 also involves multiple TRPs, which may transmit in FD operation or HD operation with a UE configured for SBFD. To handle overlapping bandwidths, the network entity may use single frequency FD (SFFD). SFFD uses the same frequency for simultaneous transmission and reception, which may provide higher throughput.

While scenarios 502 to 506 show operations in NR for a network entity that shares a frequency bandwidth spectrum with UEs, there may be another RAT that is to share spectrum. For example, NR and LTE may share spectrum as part of dynamic spectrum sharing (DSS). DSS may include a specification of LTE cell-specific reference signal rate matching patterns and an introduction of time-shifted DMRS symbols in a regular LTE subframe. DSS may also involve physical downlink control channel (PDCCH) enhancements for cross-carrier scheduling. DSS may provide cost-effective and efficient solutions for transitioning from LTE to NR. DSS also may be supported by reduced capacity (RedCap) UEs.

With the introduction of flexible duplex modes, DSS may be enhanced for flexible spectrum sharing with different RATs, including LTE and NR, NR and 6G, or LTE and 6G. When LTE and NR coexist, LTE is considered a legacy RAT, and NR is the new RAT. When NR/LTE and 6G coexist, NR/LTE is considered the legacy RAT, and 6G is the new RAT.

According to various aspects described herein, a network entity and a UE may be configured to facilitate flexible spectrum sharing between a legacy RAT and a new RAT. Flexible spectrum sharing may be applicable to LTE UEs, NR RedCap UEs, NR enhanced mobile broadband (eMBB) UEs, and 6G UEs in order to achieve coverage improvements on DL and UL channels of a new RAT, mitigate resource mapping restrictions for new RATs incurred by rate matching for a legacy RAT, and enable coexistence of multiple RATs and multiple UE types. For example, NR RedCap/eMBB UEs and LTE/eMTC UEs may share spectrum.

As indicated above, FIG. 5 is provided as an example. Other examples may differ from what is described with regard to FIG. 5.

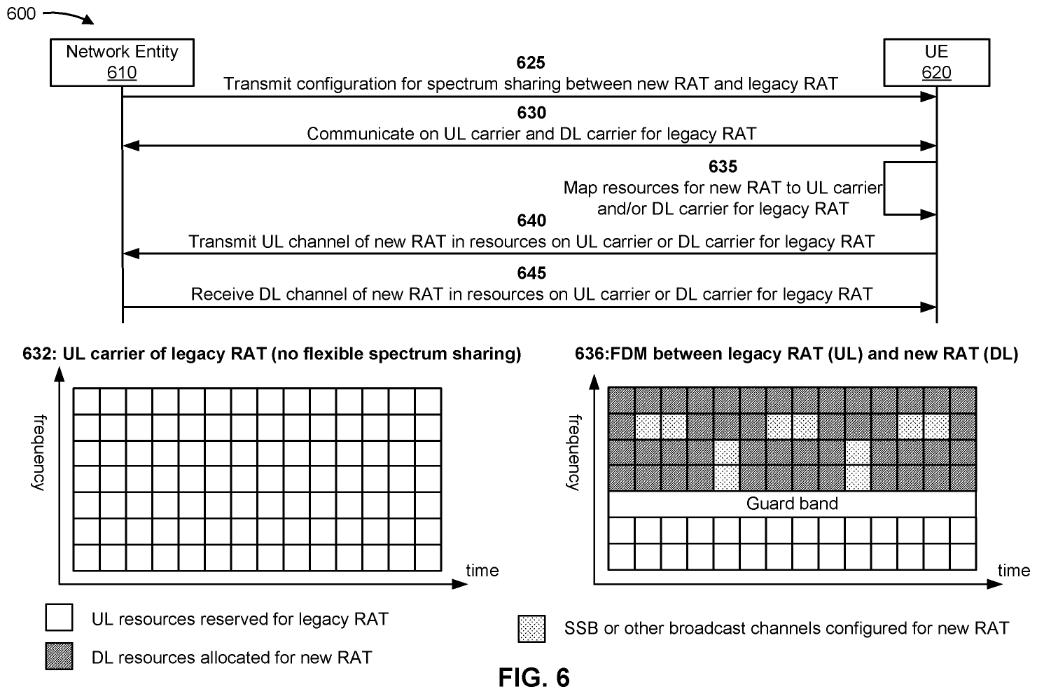

FIG. 6 is a diagram illustrating an example 600 associated with multiple RATs sharing spectrum, in accordance with the present disclosure. As shown in FIG. 6, a network entity 610 (e.g., base station 110) and a UE 620 (e.g., a UE 120) may communicate with one another on one or more networks (e.g., wireless network 100).

Example 600 shows the UE 620 transmitting an UL channel (communications on an UL channel) for a first RAT (new RAT) and a second RAT (legacy RAT). As shown by reference number 625, the network entity 610 may transmit a configuration for flexible spectrum sharing between the new RAT and the legacy RAT. The configuration may specify multiplexing communications for the new RAT and communications for the legacy RAT in a shared FDD spectrum. The network entity 610 may transmit the configuration on radio resources for the new RAT and/or on radio resources for the legacy RAT via system information, a medium access control (MAC) control element (CE), DL control information (DCI), or an RRC message.

As shown by reference number 630, the UE 620 may be communicating on an UL carrier and a DL carrier for the legacy RAT. As shown by reference number 632, the UL carrier for the legacy RAT may be used for UL transmission of the legacy RAT in FDD operation. The DL carrier for the legacy RAT may be used for DL reception of the legacy RAT in FDD operation. The legacy RAT may be operating in half duplex FDD (HD-FDD), full duplex FDD (FD-FDD), or a combination thereof. The new RAT may be operating in HD-FDD, FD-FDD, TDD, or a combination thereof.

The legacy RAT may share radio resources on UL carriers and/or DL carriers for the legacy RAT with the new RAT when the legacy RAT operates in HD-FDD, FD-FDD, or a combination thereof. Radio resources may include frequency resources, such as one or more subbands (e.g., FDD subbands), consecutive physical resource blocks (PRBs), or distributed PRBs. As shown by reference number 635, the UE 620 may map resources for the new RAT to the UL carrier and/or the DL carrier for the legacy RAT. For example, the UE 620 may map a first set of radio resources for an UL channel of the new RAT and/or a second set of radio resources for a DL channel of the new RAT to the UL carrier for the legacy RAT. The UE 620 may multiplex communications of the new RAT and communications of the legacy RAT on the UL carrier for the legacy RAT using FDM, TDM, SDM, or a combination thereof. For example, as shown by reference number 636, the UE 620 may use FDM (static or dynamic) to map radio resources for a DL channel of the new RAT on the UL carrier for the legacy RAT where UL resources for the legacy RAT were previously allocated. The radio resources mapped on the UL carrier for the new RAT may include data, synchronization signal blocks (SSBs), or other broadcast channels for the new RAT. In some aspects, there may be a guard band on the UL carrier between the resources for the DL channel of the new RAT and the UL resources for the legacy RAT. In some aspects, the UE 620 may also map resources for an UL channel and/or a DL channel of the new RAT on the DL carrier for the legacy RAT.

In some aspects, the UE 620 may configure the DL channel of the new RAT to be within a DL BWP and mapped to an edge of the UL carrier or the DL carrier for the legacy RAT. The UE 620 may also configure the UL channel of the new RAT to be within an UL BWP and mapped to an edge of the DL carrier or the UL carrier for the legacy RAT.

As shown by reference number 640, the UE 620 may transmit the UL channel of the new RAT on the UL carrier (or the DL carrier) for the legacy RAT. This may include transmitting data or control communications in the UL channel. As shown by reference number 645, the UE 620 may receive the DL channel of the new RAT on the UL carrier (or the DL carrier) for the legacy RAT. This may include receiving data or control communications in the DL channel.

By mapping resources for a DL or UL channel of the new RAT to an UL or DL carrier for the legacy RAT, the network entity 610 and the UE 620 may more efficiently share spectrum. As a result, the network entity 610 and the UE 620 may conserve signaling resources and reduce latency.

As indicated above, FIG. 6 is provided as an example. Other examples may differ from what is described with respect to FIG. 6.

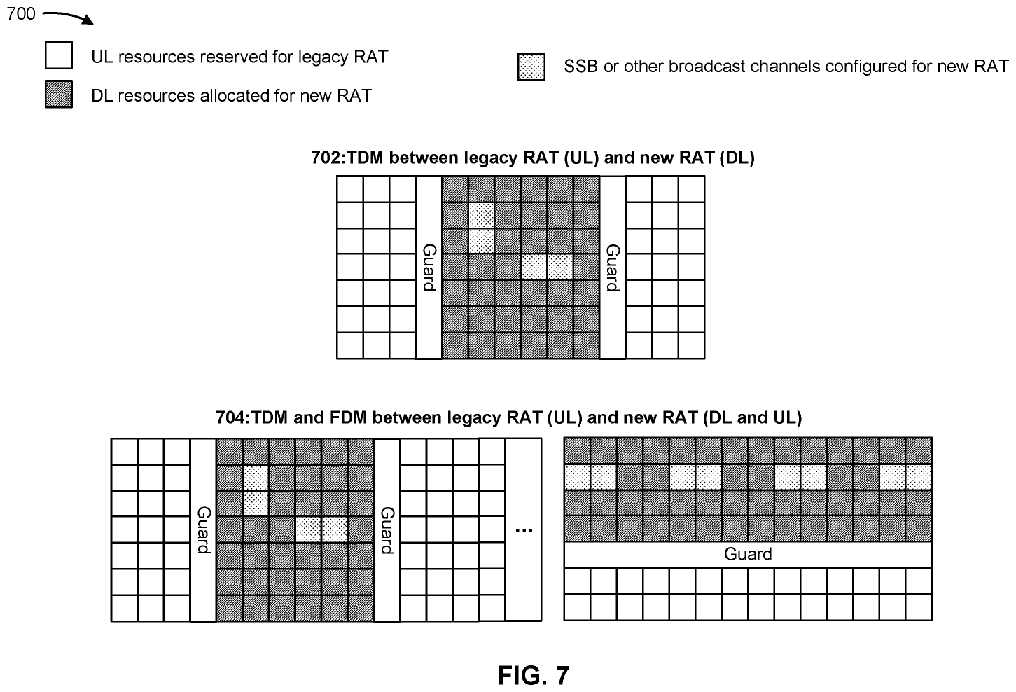

FIG. 7 is a diagram illustrating an example 700 of multiple RATs sharing spectrum, in accordance with the present disclosure.

Example 702 shows a TDM of DL resources allocated for the new RAT and UL resources reserved for the legacy RAT. More specifically, example 702 shows time resources used for UL resources reserved for the legacy RAT, a guard time or period, DL resources allocated for the new RAT, another guard time or period, and then UL resources reserved for the legacy RAT.

Example 704 shows both a TDM and an FDM of resources allocated for the new RAT and UL resources reserved for the legacy RAT. The resources allocated for the new RAT may be for both an UL channel and a DL channel.

As indicated above, FIG. 7 is provided as an example. Other examples may differ from what is described with regard to FIG. 7.

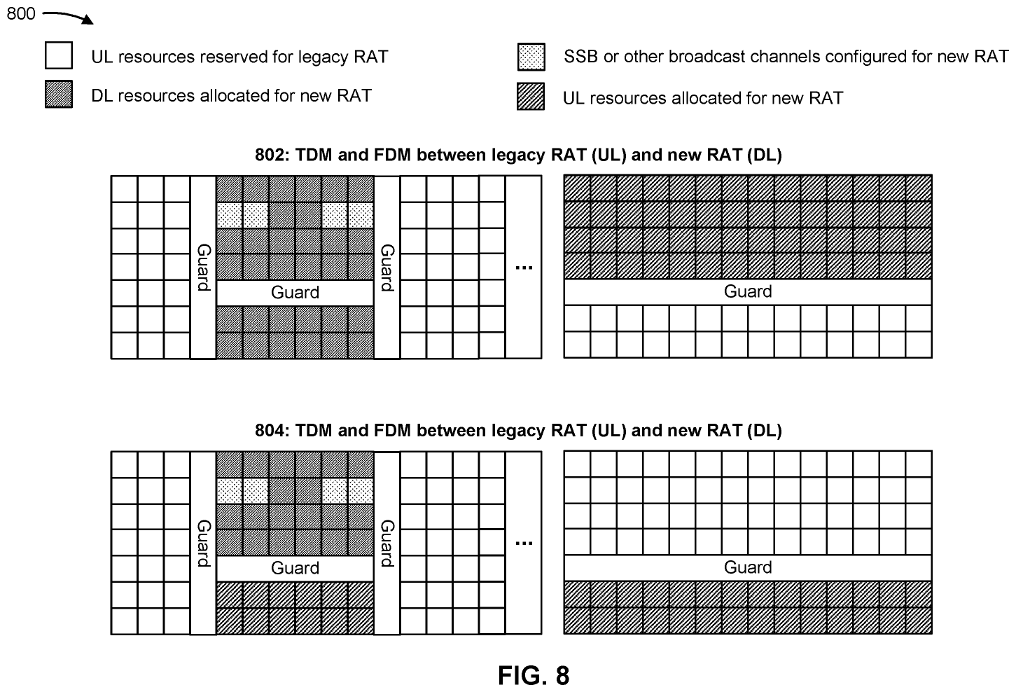

FIG. 8 is a diagram illustrating an example 800 of multiple RATs sharing spectrum, in accordance with the present disclosure.

Example 802 shows a TDM and an FDM of DL resources allocated for the new RAT, UL resources reserved for the legacy RAT, and UL resources allocated for the new RAT. Example 804 shows both a TDM and an FDM of resources allocated for the new RAT, UL resources reserved for the legacy RAT, and UL resources allocated for the new RAT, except that the DL resources allocated for the new RAT and the UL resources allocated for the new RAT may be FDMed in the same time resources (e.g., symbols) of the TDM.

As indicated above, FIG. 8 is provided as an example. Other examples may differ from what is described with regard to FIG. 8.

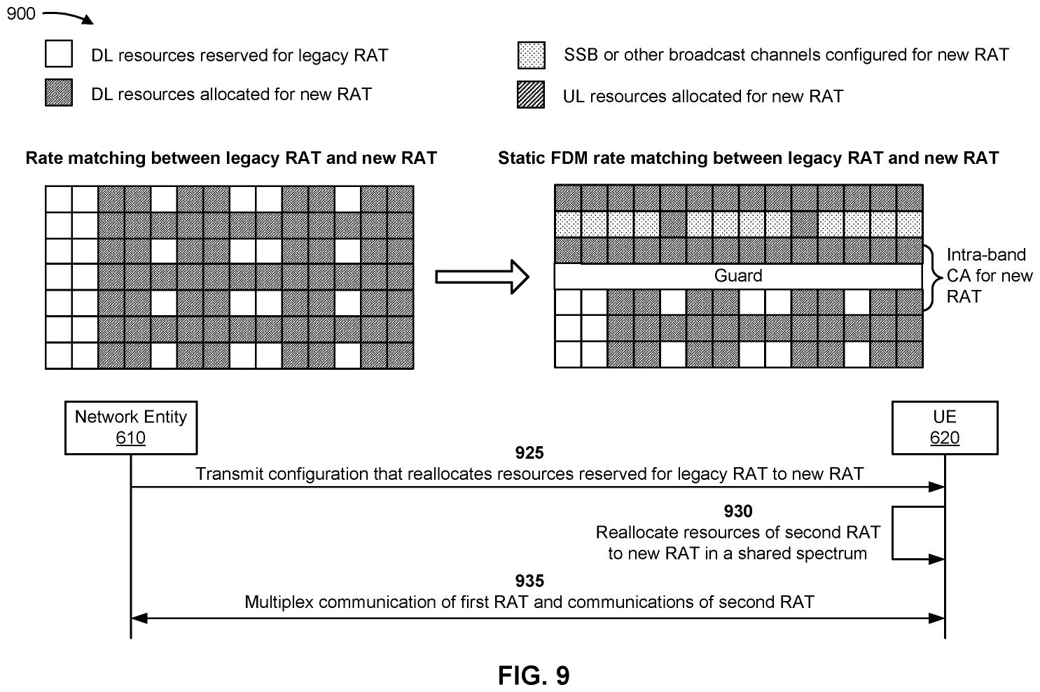

FIG. 9 is a diagram illustrating an example 900 of multiple RATs sharing spectrum, in accordance with the present disclosure.

In some aspects, flexible spectrum sharing may be based at least in part on rate matching (RM), carrier aggregation (CA), and/or dual connectivity (DC). For example, the UE 620 may map resources for the DL channel and the UL channel of the first RAT to an UL carrier or the DL carrier for the second RAT via rate matching, puncturing, spatial multiplexing, time multiplexing, frequency multiplexing, subband full duplexing, in-band full duplexing, or a combination thereof. The transmit or receive antennas of the UE can be shared between the first and the second RAT in concurrent communications.

Rate matching involves determining which bits are selected and how the bits are matched to resources that are available for transmission. This may include repeating some bits or discarding some bits depending on available resources. Rate matching in the flexible spectrum sharing context may include selecting bits to transmit using a legacy RAT or a new RAT based at least in part on a configuration for sharing spectrum. Example 900 shows allocation of reserved legacy RAT resources to the new RAT using rate matching on a more permanent basis, whether semi-static or static. As the subscribers of the new RAT increase, the network entity 610 may configure the UE 620 to reallocate more of the DL and UL resources reserved for legacy RAT to the new RAT. The reallocation on a semi-static or static basis may be referred to as “refarming.”

As shown by reference number 925, the network entity 610 may transmit a configuration that reallocates, or refarms, resources reserved for the legacy RAT to the new RAT. The resources may be for an UL channel and/or a DL channel on an UL carrier and/or a DL carrier for the legacy RAT. The configuration may be semi-static. That is, the network entity 610 may gradually refarm legacy RAT resources via system information updates or RRC reconfiguration. For example, the network entity 610 may reset UL and DL carrier parameters (e.g., reset UL-carrierBandwidth and/or DL-carrierBandwidth) via a system information block (SIB).

As shown by reference number 930, the UE 620 may reallocate, or refarm, resources reserved for the legacy RAT to the new RAT. The new RAT may be operating in HD-FDD, FD-FDD, TDD, or a combination thereof, and the legacy RAT may be operating in HD-FDD, FD-FDD, subband FDD, or a combination thereof.

The refarmed DL and UL resources of the legacy RAT can be allocated to the new RAT using FDM, TDM, SDM, or a combination thereof. As shown by reference number 935, the UE 620 (and the network entity 610) may multiplex communications of the new RAT and communications of the legacy RAT on the UL carrier or the DL carrier for the legacy RAT. The UE 620 (and the network entity 610) may use FDM, TDM, SDM, or a combination thereof. The UE 620 may reallocate UL resources or DL resources to the first RAT via rate matching

The UE 620 may operate in CA, which involves the use of multiple carriers for transmission and reception. For example, the UE 620 may transmit or receive on a first UL carrier and a second UL carrier at the same time. The UE 620 may also operate in a DC mode, which involves the use of multiple carriers for two different RATs. For example, the UE 620 may transmit or receive on a first UL carrier for LTE and on a second UL carrier for NR.

In some aspects, the UE 620 may use flexible spectrum sharing based at least in part on CA, DC, and/or RM. For example, if the UE 620 is configured to support the new RAT but is incapable of CA, the UE 620 may support the refarming of legacy RAT resources to the new RAT using rate matching. If the UE 620 is capable of CA, the UE 620 may support the refarming of resources using both rate matching and CA (intra-band and/or inter-band). In some aspects, the UE 620 may reallocate UL resources or DL resources to the first RAT in association with CA or DC.

Example 900 shows the use of intra-band CA, where the bottom set of resources below the guard includes DL resources for the legacy RAT but the top set of resources above the guard does not. The top set of resources is exclusively allocated to the new RAT. In some aspects, the network entity 610 may configure the UE 620 to use cross-division duplexing (a hybrid of TDD and FDD) to refarm resources (e.g., subbands) of FDD carriers and TDD carriers of the legacy RAT.

Puncturing involves not allocating data to some “punctured” resources such that other data may be transmitted in the punctured resources. In some aspects, puncturing in the flexible spectrum sharing context may include not allocating some resources for the legacy RAT and using those resources for the new RAT.

Spatial multiplexing, or SDM, involves transmitting multiple layers in the same time-frequency resource but in different spaces according to different sets of antennas. In some aspects, spatial multiplexing in the flexible spectrum sharing context involves transmitting in one space for the legacy RAT and another space for the new RAT.

By using one of various methods to allocate resources on an UL or DL carrier reserved for a legacy RAT to a new RAT, the network entity 610 and the UE 620 may have more flexibility to share spectrum to improve resource efficiency and to reduce latency.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120, UE 620) performs operations associated with multiple RATs sharing spectrum.

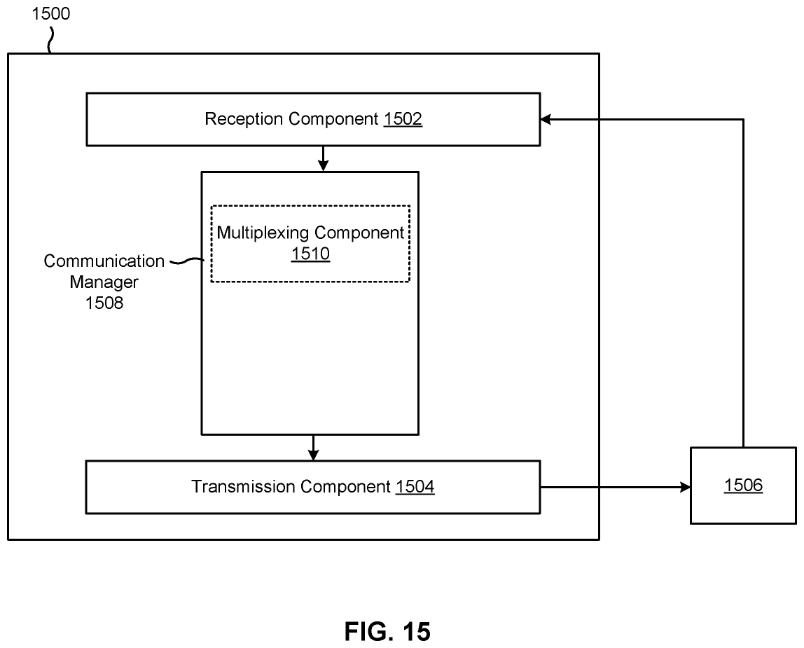

As shown in FIG. 10, in some aspects, process 1000 may include transmitting an UL channel of a first RAT in a first set of radio resources mapped to an UL carrier for a second RAT, where the UL carrier for the second RAT is used for UL transmission of the second RAT in FDD operation (block 1010). For example, the UE (e.g., using communication manager 1508 and/or transmission component 1504 depicted in FIG. 15) may transmit an UL channel of a first RAT in a first set of radio resources mapped to an UL carrier for a second RAT, where the UL carrier for the second RAT is used for UL transmission of the second RAT in FDD operation, as described above.

As further shown in FIG. 10, in some aspects, process 1000 may include receiving a DL channel of the first RAT in a second set of radio resources mapped to the UL carrier for the second RAT (block 1020). For example, the UE (e.g., using communication manager 1508 and/or reception component 1502 depicted in FIG. 15) may receive a DL channel of the first RAT in a second set of radio resources mapped to the UL carrier for the second RAT, as described above.

Process 1000 may include additional aspects, such as any single aspect or any combination of aspects described below and/or in connection with one or more other processes described elsewhere herein.

In a first aspect, process 1000 includes receiving a configuration, via system information, a MAC CE, DCI, or an RRC message, for multiplexing communications of the first RAT and communications of the second RAT in a shared FDD spectrum, where the first RAT is operating in half-duplex FDD (HD-FDD), FD-FDD, TDD, or a combination thereof, and the second RAT is operating in HD-FDD, FD-FDD, subband FDD, or a combination thereof.

In a second aspect, alone or in combination with the first aspect, the DL channel of the first RAT is configured within a DL BWP and mapped to an edge of the UL carrier or a DL carrier for the second RAT, and the UL channel of the first RAT is configured within an UL BWP and mapped to an edge of the DL carrier or the UL carrier for the second RAT.

In a third aspect, alone or in combination with one or more of the first and second aspects, process 1000 includes mapping resources for the DL channel and the UL channel of the first RAT to the UL carrier or a DL carrier for the second RAT via rate matching, puncturing, spatial multiplexing, time multiplexing, frequency multiplexing, subband full duplexing, in-band full duplexing, or a combination thereof.

In a fourth aspect, alone or in combination with one or more of the first through third aspects, process 1000 includes using a guard band between communications of the first RAT and communications of the second RAT. The size of the guard band may be configured by the network entity based at least in part on the pattern of resource multiplexing, the frequency range, the duplex mode, the numerology, and/or the UE capabilities associated with the first RAT and the second RAT.

In a fifth aspect, alone or in combination with one or more of the first through fourth aspects, the first RAT and the second RAT share the first set of radio resources or the second set of radio resources on one or more of UL carriers or DL carriers for the second RAT when the second RAT operates in HD-FDD, FD-FDD, or a combination thereof. A common reference signal, broadcast channel or random access channel for the first RAT and the second RAT can be configured on the radio resources shared between the first and the second RAT.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120, UE 620) performs operations associated with multiple RATs sharing spectrum.

As shown in FIG. 11, in some aspects, process 1100 may include transmitting an UL channel of a first RAT in a first set of radio resources mapped to a DL carrier for a second RAT, where the DL carrier for the second RAT is used for DL reception of the second RAT in FDD operation (block 1110). For example, the UE (e.g., using communication manager 1508 and/or transmission component 1504 depicted in FIG. 15) may transmit an UL channel of a first RAT in a first set of radio resources mapped to a DL carrier for a second RAT, where the DL carrier for the second RAT is used for DL reception of the second RAT in FDD operation, as described above.

As further shown in FIG. 11, in some aspects, process 1100 may include receiving a DL channel of the first RAT in a second set of radio resources mapped to the DL carrier for the second RAT (block 1120). For example, the UE (e.g., using communication manager 1508 and/or reception component 1502 depicted in FIG. 15) may receive a DL channel of the first RAT in a second set of radio resources mapped to the DL carrier for the second RAT, as described above.

Process 1100 may include additional aspects, such as any single aspect or any combination of aspects described below and/or in connection with one or more other processes described elsewhere herein.

In a first aspect, process 1100 includes receiving a configuration, via system information, MAC CE, DCI, or an RRC message, for multiplexing communications of the first RAT and communication of the second RAT in a shared FDD spectrum, where the first RAT is operating in HD-FDD, FD-FDD, TDD, subband FDD, IBFD, or a combination thereof, and the second RAT is operating in HD-FDD, FD-FDD, subband FDD, or a combination thereof.

In a second aspect, alone or in combination with the first aspect, the DL channel of the first RAT is configured within a DL BWP and mapped to an edge of an UL carrier or the DL carrier for the second RAT, and the UL channel of the first RAT is configured within an UL BWP and mapped to an edge of the DL carrier or the UL carrier for the second RAT.

In a third aspect, alone or in combination with one or more of the first and second aspects, process 1100 includes mapping resources for the DL channel and the UL channel of the first RAT to an UL carrier or the DL carrier for the second RAT via rate matching, puncturing, spatial multiplexing, time multiplexing, frequency multiplexing, subband full duplexing, in-band full duplexing, or a combination thereof.

In a fourth aspect, alone or in combination with one or more of the first through third aspects, process 1100 includes using a guard band between communications of the first RAT and communications of the second RAT. The size of the guard band may be based at least in part on a pattern of resource multiplexing, a frequency range, a duplex mode, a numerology, and/or UE capabilities associated with the first RAT and the second RAT.

In a fifth aspect, alone or in combination with one or more of the first through fourth aspects, the first RAT and the second RAT share the first set of radio resources or the second set of radio resources on one or more of UL carriers or DL carriers for the second RAT when the second RAT operates in HD-FDD, FD-FDD, subband FDD, or a combination thereof. A common reference signal, a broadcast channel, or random access channel for the first RAT and the second RAT may be configured on the first set of radio resources or the second set of radio resources shared between the first and the second RAT.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 120, UE 620) performs operations associated with multiple RATs sharing spectrum.

As shown in FIG. 12, in some aspects, process 1200 may include communicating using a first RAT on an UL channel or a DL channel in a first set of radio resources on an UL carrier or a DL carrier for a second RAT (block 1210). For example, the UE (e.g., using communication manager 1508, transmission component 1504, and/or reception component 1502 depicted in FIG. 15) may communicate using a first RAT on an UL channel or a DL channel in a first set of radio resources on an UL carrier or a DL carrier for a second RAT, as described above.

As further shown in FIG. 12, in some aspects, process 1200 may include multiplexing communications of the first RAT and communications of the second RAT on the UL carrier or the DL carrier for the second RAT using FDM, TDM, SDM, subband full duplexing, in-band full duplexing, or a combination thereof, where the first RAT is operating in HD-FDD, FD-FDD, TDD, subband FDD, IBFD, or a combination thereof, and the second RAT is operating in HD-FDD, FD-FDD, subband FDD, or a combination thereof (block 1220). For example, the UE (e.g., using communication manager 1508, multiplexing component 1510, transmission component 1504, and/or reception component 1502 depicted in FIG. 15) may multiplex communications of the first RAT and communications of the second RAT on the UL carrier or the DL carrier for the second RAT using FDM, TDM, SDM, subband full duplexing, in-band full duplexing, or a combination thereof, where the first RAT is operating in HD-FDD, FD-FDD, TDD, subband FDD, IBFD, or a combination thereof, and the second RAT is operating in HD-FDD, FD-FDD, subband FDD, or a combination thereof, as described above.

Process 1200 may include additional aspects, such as any single aspect or any combination of aspects described below and/or in connection with one or more other processes described elsewhere herein.

In a first aspect, process 1200 includes receiving a configuration for the multiplexing via system information, a MAC CE, DCI, or an RRC message.

In a second aspect, alone or in combination with the first aspect, the DL channel is configured within a DL BWP and mapped to an edge of the UL carrier or the DL carrier for the second RAT, and the UL channel of the first RAT is configured within an UL BWP and mapped to an edge of the DL carrier or the UL carrier for the second RAT.

In a third aspect, alone or in combination with one or more of the first and second aspects, process 1200 includes mapping resources for the DL channel and the UL channel of the first RAT to the UL carrier or the DL carrier for the second RAT via rate matching, puncturing, spatial multiplexing, time multiplexing, frequency multiplexing, subband full duplexing, in-band full duplexing, or a combination thereof to avoid collision with UL channels or DL channels of the second RAT.

In a fourth aspect, alone or in combination with one or more of the first through third aspects, process 1200 includes using one or more of a guard band or a guard time between the communications of the first RAT and the communications of the second RAT. The size of the guard band may be configured by the network entity and may be based at least in part on the pattern of resource multiplexing, the frequency range, the duplex mode, the numerology, and/or the UE capabilities associated with the first and the second RAT.

In a fifth aspect, alone or in combination with one or more of the first through fourth aspects, the first set of radio resources includes an FDD subband.

In a sixth aspect, alone or in combination with one or more of the first through fifth aspects, the first RAT and the second RAT dynamically share the first set of radio resources on one or more of UL carriers or DL carriers for the second RAT when the second RAT operates in HD-FDD, FD-FDD, subband FDD, or a combination thereof.

In a seventh aspect, alone or in combination with one or more of the first through sixth aspects, multiplexing the communications of the first RAT and the communications of the second RAT includes using TDM to transmit or receive the communications of the second RAT and the communications of the first RAT.

In an eighth aspect, alone or in combination with one or more of the first through seventh aspects, multiplexing the communications of the first RAT and the communications of the second RAT further includes using FDM to transmit or receive the communications of the first RAT on the UL carrier or the DL carrier concurrently with transmitting or receiving the communications of the second RAT.

In a ninth aspect, alone or in combination with one or more of the first through eighth aspects, the multiplexing further includes using FDM to transmit the communications of the first RAT on the UL carrier or the DL carrier concurrently with receiving the communications of the first RAT.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a UE, in accordance with the present disclosure. Example process 1300 is an example where the UE (e.g., UE 120, UE 620) performs operations associated with multiple RATs sharing spectrum.

As shown in FIG. 13, in some aspects, process 1300 may include receiving a configuration that reallocates, to a first RAT, UL resources or DL resources reserved for a second RAT on an UL carrier or a DL carrier for the second RAT (block 1310). For example, the UE (e.g., using communication manager 1508 and/or reception component 1502 depicted in FIG. 15) may receive a configuration that reallocates, to a first RAT, UL resources or DL resources reserved for a second RAT on an UL carrier or a DL carrier for the second RAT, as described above.

As further shown in FIG. 13, in some aspects, process 1300 may include multiplexing, based at least in part on the configuration, communications of the first RAT and communications of the second RAT in a shared spectrum using FDM, TDM, SDM, subband full duplexing, in-band full duplexing, or a combination thereof (block 1320). For example, the UE (e.g., using communication manager 1508, multiplexing component 1510, transmission component 1504, and/or reception component 1502 depicted in FIG. 15) may multiplex, based at least in part on the configuration, communications of the first RAT and communications of the second RAT in a shared spectrum using FDM, TDM, SDM, subband full duplexing, in-band full duplexing, or a combination thereof, as described above.

Process 1300 may include additional aspects, such as any single aspect or any combination of aspects described below and/or in connection with one or more other processes described elsewhere herein.

In a first aspect, receiving the configuration includes receiving the configuration via system information, a MAC CE, or an RRC message, and the configuration is semi-static.

In a second aspect, alone or in combination with the first aspect, reallocating UL resources or DL resources to the first RAT includes reallocating UL resources or DL resources to the first RAT via FDM, TDM, SDM, subband full duplexing, in-band full duplexing, or a combination thereof.

In a third aspect, alone or in combination with one or more of the first and second aspects, reallocating UL resources or DL resources to the first RAT includes reallocating UL resources or DL resources to the first RAT via rate matching.

In a fourth aspect, alone or in combination with one or more of the first through third aspects, reallocating UL resources or DL resources to the first RAT includes reallocating UL resources or DL resources to the first RAT in association with CA or DC. The transmit or receive antennas of the UE can be shared between the first and the second RAT in concurrent communications. The transmit or receive antennas of the UE may be shared between the first and the second RAT.

In a fifth aspect, alone or in combination with one or more of the first through fourth aspects, reallocating UL resources or DL resources to the first RAT includes reallocating UL resources or DL resources to the first RAT in radio resources of one or more of an FDD carrier for the second RAT or a TDD carrier for the second RAT.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network entity, in accordance with the present disclosure. Example process 1400 is an example where the network entity (e.g., base station 110, network entity 610) performs operations associated with multiple RATs sharing spectrum.

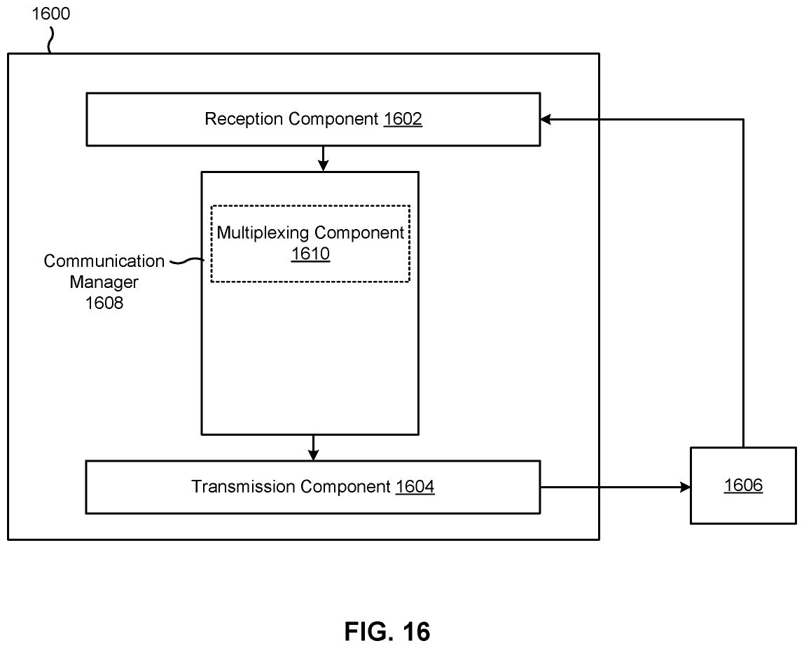

As shown in FIG. 14, in some aspects, process 1400 may include communicating using a first RAT on an UL channel or a DL channel in a first set of radio resources on an UL carrier or a DL carrier for a second RAT (block 1410). For example, the network entity (e.g., using communication manager 1608, transmission component 1604, and/or reception component 1602 depicted in FIG. 16) may communicate using a first RAT on an UL channel or a DL channel in a first set of radio resources on an UL carrier or a DL carrier for a second RAT, as described above.

As further shown in FIG. 14, in some aspects, process 1400 may include multiplexing communications of the first RAT and communications of the second RAT on the UL carrier or the DL carrier for the second RAT using FDM, TDM, SDM, subband full duplexing, in-band full duplexing, or a combination thereof, where the first RAT is operating in HD-FDD, FD-FDD, TDD, subband FDD, IBFD, or a combination thereof, and the second RAT is operating in HD-FDD, FD-FDD, subband FDD, or a combination thereof (block 1420). For example, the network entity (e.g., using communication manager 1608, multiplexing component 1610, transmission component 1604, and/or reception component 1602 depicted in FIG. 16) may multiplex communications of the first RAT and communications of the second RAT on the UL carrier or the DL carrier for the second RAT using FDM, TDM, SDM, subband full duplexing, in-band full duplexing, or a combination thereof, where the first RAT is operating in HD-FDD, FD-FDD, TDD, subband FDD, IBFD, or a combination thereof, and the second RAT is operating in HD-FDD, FD-FDD, subband FDD, or a combination thereof, as described above.

Process 1400 may include additional aspects, such as any single aspect or any combination of aspects described below and/or in connection with one or more other processes described elsewhere herein.

In a first aspect, process 1400 includes transmitting a configuration for the multiplexing via system information, a MAC CE, DCI, or an RRC message.

In a second aspect, alone or in combination with the first aspect, the DL channel is configured within a DL BWP and mapped to an edge of the UL carrier or the DL carrier for the second RAT, and the UL channel of the first RAT is configured within an UL BWP and mapped to an edge of the DL carrier or the UL carrier for the second RAT.

In a third aspect, alone or in combination with one or more of the first and second aspects, the first set of radio resources includes an FDD subband.

In a fourth aspect, alone or in combination with one or more of the first through third aspects, the first RAT and the second RAT dynamically share the first set of radio resources on one or more of UL carriers or DL carriers for the second RAT when the second RAT operates in HD-FDD, FD-FDD, subband FDD, or a combination thereof.

In a fifth aspect, alone or in combination with one or more of the first through fourth aspects, multiplexing the communications of the first RAT and the communications of the second RAT includes using TDM to transmit or receive the communications of the second RAT and the communications of the first RAT.

In a sixth aspect, alone or in combination with one or more of the first through fifth aspects, multiplexing the communications of the first RAT and the communications of the second RAT further includes using FDM to transmit or receive the communications of the first RAT on the UL carrier or the DL carrier concurrently with transmitting or receiving the communications of the second RAT.

In a seventh aspect, alone or in combination with one or more of the first through sixth aspects, the multiplexing further includes using FDM to transmit the communications of the first RAT on the UL carrier or the DL carrier concurrently with receiving the communications of the first RAT.

In an eighth aspect, alone or in combination with one or more of the first through seventh aspects, process 1400 includes transmitting a configuration that semi-statically reallocates UL resources or DL resources reserved for the second RAT to the first RAT.

In a ninth aspect, alone or in combination with one or more of the first through eighth aspects, the UL resources or DL resources are allocated to the first RAT via FDM, TDM, SDM, subband full duplexing, in-band full duplexing, or a combination thereof.

In a tenth aspect, alone or in combination with one or more of the first through ninth aspects, the UL resources or DL resources are allocated to the first RAT via rate matching or in association with CA or DC. The transmit or receive antennas of the UE can be shared between the first and the second RAT in concurrent communications.

In an eleventh aspect, alone or in combination with one or more of the first through tenth aspects, the UL resources or DL resources are allocated to the first RAT in radio resources of one or more of an FDD carrier for the second RAT or a TDD carrier for the second RAT.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a UE (e.g., a UE 120, UE 620), or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. The communication manager 1508 may control and/or otherwise manage one or more operations of the reception component 1502 and/or the transmission component 1504. In some aspects, the communication manager 1508 may include one or more antennas, a modem, a controller/processor, a memory, or a combination thereof, of the UE described in connection with FIG. 2. The communication manager 1508 may be, or be similar to, the communication manager 140 depicted in FIGS. 1 and 2. For example, in some aspects, the communication manager 1508 may be configured to perform one or more of the functions described as being performed by the communication manager 140. In some aspects, the communication manager 1508 may include the reception component 1502 and/or the transmission component 1504. The communication manager 1508 may include a multiplexing component 1510, among other examples.

In some aspects, the apparatus 1500 may be configured to perform one or more operations described herein in connection with FIGS. 1-9. Additionally, or alternatively, the apparatus 1500 may be configured to perform one or more processes described herein, such as process 1000 of FIG. 10, process 1100 of FIG. 11, process 1200 of FIG. 12, process 1300 of FIG. 13, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

In some aspects, the transmission component 1504 may transmit an UL channel of a first RAT in a first set of radio resources mapped to an UL carrier for a second RAT, where the UL carrier for the second RAT is used for UL transmission of the second RAT in FDD operation. The reception component 1502 may receive a DL channel of the first RAT in a second set of radio resources mapped to the UL carrier for the second RAT.

The reception component 1502 may receive a configuration, via system information, a MAC CE, DCI, or an RRC message, for multiplexing communications of the first RAT and communications of the second RAT in a shared FDD spectrum, where the first RAT is operating in HD-FDD, FD-FDD, TDD, subband FDD, IBFD, or a combination thereof, and the second RAT is operating in HD-FDD, FD-FDD, subband FDD, or a combination thereof. The transmission component 1504 and/or the reception component 1502 may use a guard band between communications of the first RAT and communications of the second RAT.

In some aspects, the transmission component 1504 may transmit an UL channel of a first RAT in a first set of radio resources mapped to a DL carrier for a second RAT, where the DL carrier for the second RAT is used for DL reception of the second RAT in FDD operation. The reception component 1502 may receive a DL channel of the first RAT in a second set of radio resources mapped to the DL carrier for the second RAT.

In some aspects, the transmission component 1504 and/or the reception component 1502 may communicate using a first RAT on an UL channel or a DL channel in a first set of radio resources on an UL carrier or a DL carrier for a second RAT. The multiplexing component 1510, the transmission component 1504, and/or the reception component 1502 may multiplex communications of the first RAT and communications of the second RAT on the UL carrier or the DL carrier for the second RAT using FDM, TDM, SDM, subband full duplexing, in-band full duplexing, or a combination thereof, where the first RAT is operating in HD-FDD, FD-FDD, TDD, subband FDD, IBFD, or a combination thereof, and the second RAT is operating in HD-FDD, FD-FDD, subband FDD, or a combination thereof.

In some aspects, the reception component 1502 may receive a configuration that reallocates, to a first RAT, UL resources or DL resources reserved for a second RAT on an UL carrier or a DL carrier for the second RAT. The multiplexing component 1510, the transmission component 1504, and/or the reception component 1502 may multiplex, based at least in part on the configuration, communications of the first RAT and communications of the second RAT in a shared spectrum using FDM, TDM, SDM, subband full duplexing, in-band full duplexing, or a combination thereof.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication. The apparatus 1600 may be a network entity (e.g., base station 110, network entity 610), or a network entity may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 1608. The communication manager 1608 may control and/or otherwise manage one or more operations of the reception component 1602 and/or the transmission component 1604. In some aspects, the communication manager 1608 may include one or more antennas, a modem, a controller/processor, a memory, or a combination thereof, of the network entity described in connection with FIG. 2. The communication manager 1608 may be, or be similar to, the communication manager 150 depicted in FIGS. 1 and 2. For example, in some aspects, the communication manager 1608 may be configured to perform one or more of the functions described as being performed by the communication manager 150. In some aspects, the communication manager 1608 may include the reception component 1602 and/or the transmission component 1604. The communication manager 1608 may include a multiplexing component 1610, among other examples.

In some aspects, the apparatus 1600 may be configured to perform one or more operations described herein in connection with FIGS. 1-9. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the network entity described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network entity described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network entity described in connection with FIG. 2. In some aspects, the transmission component 1604 may be co-located with the reception component 1602 in a transceiver.

The transmission component 1604 and/or the reception component 1602 may communicate using a first RAT on an UL channel or a DL channel in a first set of radio resources on an UL carrier or a DL carrier for a second RAT. The multiplexing component 1610, the transmission component 1604, and/or the reception component 1602 may multiplex communications of the first RAT and communications of the second RAT on the UL carrier or the DL carrier for the second RAT using FDM, TDM, SDM, subband full duplexing, in-band full duplexing, or a combination thereof, where the first RAT is operating in HD-FDD, FD-FDD, TDD, subband FDD, IBFD, or a combination thereof, and the second RAT is operating in HD-FDD, FD-FDD, subband FDD, or a combination thereof.

The transmission component 1604 may transmit a configuration for the multiplexing via system information, a MAC CE, DCI, or an RRC message. The transmission component 1604 may transmit a configuration that semi-statically reallocates UL resources or DL resources reserved for the second RAT to the first RAT.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a user equipment (UE), comprising: transmitting an uplink (UL) channel of a first radio access technology (RAT) in a first set of radio resources mapped to an UL carrier for a second RAT, wherein the UL carrier for the second RAT is used for UL transmission of the second RAT in frequency division duplex (FDD) operation; and receiving a downlink (DL) channel of the first RAT in a second set of radio resources mapped to the UL carrier for the second RAT.

Aspect 2: The method of Aspect 1, further comprising receiving a configuration, via system information, a medium access control (MAC) control element (CE), DL control information, or a radio resource control message, for multiplexing communications of the first RAT and communications of the second RAT in a shared FDD spectrum, wherein the first RAT is operating in half-duplex FDD (HD-FDD), full-duplex FDD (FD-FDD), time division duplex (TDD), subband FDD, in-band full duplex, or a combination thereof, and wherein the second RAT is operating in HD-FDD, FD-FDD, subband FDD, or a combination thereof.

Aspect 3: The method of Aspect 1 or 2, wherein the DL channel of the first RAT is configured within a DL bandwidth part (BWP) and mapped to an edge of the UL carrier or a DL carrier for the second RAT, and wherein the UL channel of the first RAT is configured within an UL BWP and mapped to an edge of the DL carrier or the UL carrier for the second RAT.

Aspect 4: The method of any of Aspects 1-3, further comprising mapping resources for the DL channel and the UL channel of the first RAT to the UL carrier or a DL carrier for the second RAT via rate matching, puncturing, spatial multiplexing, time multiplexing, frequency multiplexing, subband full duplexing, in-band full duplexing, or a combination thereof.

Aspect 5: The method of any of Aspects 1-4, further comprising using a guard band between communications of the first RAT and communications of the second RAT, and wherein a size of the guard band is based at least in part on one or more of a pattern of resource multiplexing, a frequency range, a duplex mode, a numerology, or UE capabilities associated with the first RAT and the second RAT.

Aspect 6: The method of any of Aspects 1-5, wherein the first RAT and the second RAT share the first set of radio resources or the second set of radio resources on one or more of UL carriers or DL carriers for the second RAT when the second RAT operates in half-duplex FDD (HD-FDD), full-duplex FDD (FD-FDD), subband FDD, or a combination thereof, and wherein a common reference signal, a broadcast channel, or random access channel for the first RAT and the second RAT are configured on the first set of radio resources or the second set of radio resources shared between the first and the second RAT.

Aspect 7: A method of wireless communication performed by a user equipment (UE), comprising: transmitting an uplink (UL) channel of a first radio access technology (RAT) in a first set of radio resources mapped to a downlink (DL) carrier for a second RAT, wherein the DL carrier for the second RAT is used for DL reception of the second RAT in frequency division duplex (FDD) operation; and receiving a DL channel of the first RAT in a second set of radio resources mapped to the DL carrier for the second RAT.

Aspect 8: The method of Aspect 7, further comprising receiving a configuration, via system information, a medium access control (MAC) control element (CE), DL control information, or a radio resource control message, for multiplexing communications of the first RAT and communication of the second RAT in a shared FDD spectrum, wherein the first RAT is operating in half-duplex FDD (HD-FDD), full-duplex FDD (FD-FDD), time division duplex (TDD), subband FDD, in-band full duplex, or a combination thereof, and wherein the second RAT is operating in HD-FDD, FD-FDD, subband FDD, or a combination thereof.

Aspect 9: The method of Aspect 7 or 8, wherein the DL channel of the first RAT is configured within a DL bandwidth part (BWP) and mapped to an edge of an UL carrier or the DL carrier for the second RAT, and wherein the UL channel of the first RAT is configured within an UL BWP and mapped to an edge of the DL carrier or the UL carrier for the second RAT.

Aspect 10: The method of any of Aspects 7-9, further comprising mapping resources for the DL channel and the UL channel of the first RAT to an UL carrier or the DL carrier for the second RAT via rate matching, puncturing, spatial multiplexing, time multiplexing, frequency multiplexing, subband full duplexing, in-band full duplexing, or a combination thereof.

Aspect 11: The method of any of Aspects 7-10, further comprising using a guard band between communications of the first RAT and communications of the second RAT.

Aspect 12: The method of any of Aspects 7-11, wherein the first RAT and the second RAT share the first set of radio resources or the second set of radio resources on one or more of UL carriers or DL carriers for the second RAT when the second RAT operates in half-duplex FDD (HD-FDD), full-duplex FDD (FD-FDD), subband FDD, or a combination thereof.

Aspect 13: A method of wireless communication performed by a user equipment (UE), comprising: communicating using a first radio access technology (RAT) on an uplink (UL) channel or a downlink (DL) channel in a first set of radio resources on an UL carrier or a DL carrier for a second RAT; and multiplexing communications of the first RAT and communications of the second RAT on the UL carrier or the DL carrier for the second RAT using frequency division multiplexing (FDM), time division multiplexing (TDM), spatial division multiplexing (SDM), or a combination thereof, wherein the first RAT is operating in half-duplex frequency division duplex (HD-FDD), full-duplex FDD (FD-FDD), time division duplex (TDD), subband FDD, in-band full duplex, or a combination thereof, and wherein the second RAT is operating in HD-FDD, FD-FDD, subband FDD, or a combination thereof.

Aspect 14: The method of Aspect 13, further comprising receiving a configuration for the multiplexing via system information, a medium access control (MAC) control element (CE), DL control information, or a radio resource control message.

Aspect 15: The method of Aspect 13 or 14, wherein the DL channel is configured within a DL bandwidth part (BWP) and mapped to an edge of the UL carrier or the DL carrier for the second RAT, and wherein the UL channel of the first RAT is configured within an UL BWP and mapped to an edge of the DL carrier or the UL carrier for the second RAT.

Aspect 16: The method of any of Aspects 13-15, further comprising mapping resources for the DL channel and the UL channel of the first RAT to the UL carrier or the DL carrier for the second RAT via rate matching, puncturing, spatial multiplexing, time multiplexing, frequency multiplexing, subband full duplexing, in-band full duplexing, or a combination thereof to avoid collision with UL channels or DL channels of the second RAT.

Aspect 17: The method of any of Aspects 13-16, further comprising using one or more of a guard band or a guard time between the communications of the first RAT and the communications of the second RAT, and wherein a size of the guard band or the guard time is based at least in part on one or more of a pattern of resource multiplexing, a frequency range, a duplex mode, a numerology, or UE capabilities associated with the first and the second RAT.

Aspect 18: The method of any of Aspects 13-17, wherein the first set of radio resources includes an FDD subband.

Aspect 19: The method of any of Aspects 13-18, wherein the first RAT and the second RAT dynamically share the first set of radio resources on one or more of UL carriers or DL carriers for the second RAT when the second RAT operates in HD-FDD, FD-FDD, subband FDD, or a combination thereof.

Aspect 20: The method of any of Aspects 13-19, wherein multiplexing the communications of the first RAT and the communications of the second RAT includes using TDM to transmit or receive the communications of the second RAT and the communications of the first RAT.

Aspect 21: The method of Aspect 20, wherein multiplexing the communications of the first RAT and the communications of the second RAT further includes using FDM to transmit or receive the communications of the first RAT on the UL carrier or the DL carrier concurrently with transmitting or receiving the communications of the second RAT.

Aspect 22: The method of Aspect 21, wherein the multiplexing further includes using FDM to transmit the communications of the first RAT on the UL carrier or the DL carrier concurrently with receiving the communications of the first RAT.

Aspect 23: A method of wireless communication performed by a user equipment (UE), comprising: receiving a configuration that reallocates, to a first radio access technology (RAT), uplink (UL) resources or downlink (DL) resources reserved for a second RAT on an UL carrier or a DL carrier for the second RAT; and multiplexing, based at least in part on the configuration, communications of the first RAT and communications of the second RAT in a shared spectrum using frequency division multiplexing (FDM), time division multiplexing (TDM), spatial division multiplexing (SDM), subband full duplexing, in-band full duplexing, or a combination thereof.

Aspect 24: The method of Aspect 23, wherein receiving the configuration includes receiving the configuration via system information, a medium access control (MAC) control element (CE), or a radio resource control message, and wherein the configuration is semi-static.

Aspect 25: The method of Aspect 23 or 24, wherein reallocating UL resources or DL resources to the first RAT includes reallocating UL resources or DL resources to the first RAT via FDM, TDM, SDM, subband full duplexing, in-band full duplexing, or a combination thereof.

Aspect 26: The method of any of Aspects 23-25, wherein reallocating UL resources or DL resources to the first RAT includes reallocating UL resources or DL resources to the first RAT via rate matching.

Aspect 27: The method of any of Aspects 23-26, wherein reallocating UL resources or DL resources to the first RAT includes reallocating UL resources or DL resources to the first RAT in association with carrier aggregation or dual connectivity, and wherein transmit or receive antennas of the UE are shared between the first and the second RAT.

Aspect 28: The method of any of Aspects 23-27, wherein reallocating UL resources or DL resources to the first RAT includes reallocating UL resources or DL resources to the first RAT in radio resources of one or more of a frequency division duplex carrier for the second RAT or a time division duplex carrier for the second RAT.

Aspect 29: A method of wireless communication performed by a network entity, comprising: communicating using a first radio access technology (RAT) on an uplink (UL) channel or a downlink (DL) channel in a first set of radio resources on an UL carrier or a DL carrier for a second RAT; and multiplexing communications of the first RAT and communications of the second RAT on the UL carrier or the DL carrier for the second RAT using frequency division multiplexing (FDM), time division multiplexing (TDM), spatial division multiplexing (SDM), subband full duplexing, in-band full duplexing, or a combination thereof, wherein the first RAT is operating in half-duplex frequency division duplex (HD-FDD), full-duplex FDD (FD-FDD), time division duplex (TDD), subband FDD, in-band full duplex, or a combination thereof, and wherein the second RAT is operating in HD-FDD, FD-FDD, subband FDD, or a combination thereof.

Aspect 30: The method of Aspect 29, further comprising transmitting a configuration for the multiplexing via system information, a medium access control (MAC) control element (CE), DL control information, or a radio resource control message.

Aspect 31: The method of Aspect 29 or 30, wherein the DL channel is configured within a DL bandwidth part (BWP) and mapped to an edge of the UL carrier or the DL carrier for the second RAT, and wherein the UL channel of the first RAT is configured within an UL BWP and mapped to an edge of the DL carrier or the UL carrier for the second RAT.

Aspect 32: The method of any of Aspects 29-31, wherein the first set of radio resources includes an FDD subband.

Aspect 33: The method of any of Aspects 29-32, wherein the first RAT and the second RAT dynamically share the first set of radio resources on one or more of UL carriers or DL carriers for the second RAT when the second RAT operates in HD-FDD, FD-FDD, or a combination thereof.

Aspect 34: The method of any of Aspects 29-33, wherein multiplexing the communications of the first RAT and the communications of the second RAT includes using TDM to transmit or receive the communications of the second RAT and the communications of the first RAT.

Aspect 35: The method of Aspect 34, wherein multiplexing the communications of the first RAT and the communications of the second RAT further includes using FDM to transmit or receive the communications of the first RAT on the UL carrier or the DL carrier concurrently with transmitting or receiving the communications of the second RAT.

Aspect 36: The method of Aspect 35, wherein the multiplexing further includes using FDM to transmit the communications of the first RAT on the UL carrier or the DL carrier concurrently with receiving the communications of the first RAT.

Aspect 37: The method of any of Aspects 29-36, further comprising transmitting a configuration that semi-statically reallocates UL resources or DL resources reserved for the second RAT to the first RAT.

Aspect 38: The method of any of Aspects 29-37, wherein the UL resources or DL resources are allocated to the first RAT via FDM, TDM, SDM, subband full duplexing, in-band duplexing, or a combination thereof.

Aspect 39: The method of any of Aspects 29-38, wherein the UL resources or DL resources are allocated to the first RAT via rate matching or in association with carrier aggregation or dual connectivity.

Aspect 40: The method of any of Aspects 29-39, wherein the UL resources or DL resources are allocated to the first RAT in radio resources of one or more of an FDD carrier for the second RAT or a TDD carrier for the second RAT.

Aspect 41: An apparatus for wireless communication at a device, comprising a processor; memory coupled with the processor; and instructions stored in the memory and executable by the processor to cause the apparatus to perform the method of one or more of Aspects 1-40.

Aspect 42: A device for wireless communication, comprising a memory and one or more processors coupled to the memory, the one or more processors configured to perform the method of one or more of Aspects 1-40.

Aspect 43: An apparatus for wireless communication, comprising at least one means for performing the method of one or more of Aspects 1-40.

Aspect 44: A non-transitory computer-readable medium storing code for wireless communication, the code comprising instructions executable by a processor to perform the method of one or more of Aspects 1-40.

Aspect 45: A non-transitory computer-readable medium storing a set of instructions for wireless communication, the set of instructions comprising one or more instructions that, when executed by one or more processors of a device, cause the device to perform the method of one or more of Aspects 1-40.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit an uplink (UL) channel of a first radio access technology (RAT) in a first set of radio resources mapped to an UL carrier for a second RAT, wherein the UL carrier for the second RAT is used for UL transmission of the second RAT in frequency division duplex (FDD) operation; and
receive a downlink (DL) channel of the first RAT in a second set of radio resources mapped to the UL carrier for the second RAT.

2. The UE of claim 1, wherein the one or more processors are configured to receive a configuration, via system information, DL control information, a medium access control (MAC) control element (CE), or a radio resource control (RRC) message, for multiplexing communications of the first RAT and communications of the second RAT in a shared FDD spectrum, wherein the first RAT is operating in half-duplex FDD (HD-FDD), full-duplex FDD (FD-FDD), time division duplex (TDD), subband full FDD, in-band full duplex, or a combination thereof, and wherein the second RAT is operating in HD-FDD, FD-FDD, subband FDD, or a combination thereof.

3. The UE of claim 1, wherein the DL channel of the first RAT is configured within a DL bandwidth part (BWP) and mapped to an edge of the UL carrier or a DL carrier for the second RAT, and wherein the UL channel of the first RAT is configured within an UL BWP and mapped to an edge of the DL carrier or the UL carrier for the second RAT.

4. The UE of claim 1, wherein the one or more processors are configured to map resources for the DL channel and the UL channel of the first RAT to the UL carrier or a DL carrier for the second RAT via rate matching, puncturing, spatial multiplexing, time multiplexing, frequency multiplexing, subband full duplexing, in-band full duplexing, or a combination thereof.

5. The UE of claim 1, wherein the one or more processors are configured to use a guard band between communications of the first RAT and communications of the second RAT, and wherein a size of the guard band is based at least in part on one or more of a pattern of resource multiplexing, a frequency range, a duplex mode, a numerology, or UE capabilities associated with the first RAT and the second RAT.

6. The UE of claim 1, wherein the first RAT and the second RAT share the first set of radio resources or the second set of radio resources on one or more of UL carriers or DL carriers for the second RAT when the second RAT operates in half-duplex FDD (HD-FDD), full-duplex FDD (FD-FDD), subband FDD, or a combination thereof, and wherein a common reference signal, a broadcast channel, or random access channel for the first RAT and the second RAT are configured on the first set of radio resources or the second set of radio resources shared between the first and the second RAT.

7. A user equipment (UE) for wireless communication, comprising:
a memory; and
one or more processors, coupled to the memory, configured to:
transmit an uplink (UL) channel of a first radio access technology (RAT) in a first set of radio resources mapped to a downlink (DL) carrier for a second RAT, wherein the DL carrier for the second RAT is used for DL reception of the second RAT in frequency division duplex (FDD) operation; and
receive a DL channel of the first RAT in a second set of radio resources mapped to the DL carrier for the second RAT.

8. The UE of claim 7, wherein the one or more processors are configured to receive a configuration, via system information, DL control information, a medium access control (MAC) control element (CE), or a radio resource control message, for multiplexing communications of the first RAT and communication of the second RAT in a shared FDD spectrum, wherein the first RAT is operating in half-duplex FDD (HD-FDD), full-duplex FDD (FD-FDD), time division duplex (TDD), subband FDD, in-band full duplex, or a combination thereof, and wherein the second RAT is operating in HD-FDD, FD-FDD, subband FDD, or a combination thereof.

9. The UE of claim 7, wherein the DL channel of the first RAT is configured within a DL bandwidth part (BWP) and mapped to an edge of an UL carrier or the DL carrier for the second RAT, and wherein the UL channel of the first RAT is configured within an UL BWP and mapped to an edge of the DL carrier or the UL carrier for the second RAT.

10. The UE of claim 7, wherein the one or more processors are configured to map resources for the DL channel and the UL channel of the first RAT to an UL carrier or the DL carrier for the second RAT via rate matching, puncturing, spatial multiplexing, time multiplexing, frequency multiplexing, subband full duplexing, in-band full duplexing, or a combination thereof.

11. The UE of claim 7, wherein the one or more processors are configured to use a guard band between communications of the first RAT and communications of the second RAT, and wherein a size of the guard band is based at least in part on one or more of a pattern of resource multiplexing, a frequency range, a duplex mode, a numerology, or UE capabilities associated with the first RAT and the second RAT.

12. The UE of claim 7, wherein the first RAT and the second RAT share the first set of radio resources or the second set of radio resources on one or more of UL carriers or DL carriers for the second RAT when the second RAT operates in half-duplex FDD (HD-FDD), full-duplex FDD (FD-FDD), sub-band FDD, or a combination thereof, and wherein a common reference signal, a broadcast channel, or random access channel for the first RAT and the second RAT are configured on the first set of radio resources or the second set of radio resources shared between the first and the second RAT.

13. A user equipment (UE) for wireless communication, comprising:
a memory; and
one or more processors, coupled to the memory, configured to:
communicate using a first radio access technology (RAT) on an uplink (UL) channel or a downlink (DL) channel in a first set of radio resources on an UL carrier or a DL carrier for a second RAT; and
multiplex communications of the first RAT and communications of the second RAT on the UL carrier or the DL carrier for the second RAT using frequency division multiplexing (FDM), time division multiplexing (TDM), spatial division multiplexing (SDM), subband full duplexing, in-band full duplexing, or a combination thereof, wherein the first RAT is operating in half-duplex frequency division duplex (HD-FDD), full-duplex FDD (FD-FDD), time division duplex (TDD), subband FDD, in-band full duplex, or a combination thereof, and wherein the second RAT is operating in HD-FDD, FD-FDD, subband FDD, or a combination thereof.

14. The UE of claim 13, wherein the one or more processors are configured to receive a configuration for the multiplexing via system information, a medium access control (MAC) control element (CE), DL control information, or a radio resource control message.

15. The UE of claim 13, wherein the DL channel is configured within a DL bandwidth part (BWP) and mapped to an edge of the UL carrier or the DL carrier for the second RAT, and wherein the UL channel of the first RAT is configured within an UL BWP and mapped to an edge of the DL carrier or the UL carrier for the second RAT.

16. The UE of claim 13, wherein the one or more processors are configured to map resources for the DL channel and the UL channel of the first RAT to the UL carrier or the DL carrier for the second RAT via rate matching, puncturing, spatial multiplexing, time multiplexing, frequency multiplexing, subband full duplexing, in-band full duplexing, or a combination thereof to avoid collision with UL channels or DL channels of the second RAT.

17. The UE of claim 13, wherein the one or more processors are configured to use one or more of a guard band or a guard time between the communications of the first RAT and the communications of the second RAT, and wherein a size of the guard band or the guard time is based at least in part on one or more of a pattern of resource multiplexing, a frequency range, a duplex mode, a numerology, or UE capabilities associated with the first and the second RAT.

18. The UE of claim 13, wherein the first set of radio resources includes a frequency division duplex subband.

19. The UE of claim 13, wherein the first RAT and the second RAT dynamically share the first set of radio resources on one or more of UL carriers or DL carriers for the second RAT when the second RAT operates in HD-FDD, FD-FDD, subband FDD, or a combination thereof.

20. The UE of claim 13, wherein the one or more processors, to multiplex the communications of the first RAT and the communications of the second RAT, are configured to use TDM to transmit or receive the communications of the second RAT and the communications of the first RAT.

21. The UE of claim 20, wherein the one or more processors, to multiplex the communications of the first RAT and the communications of the second RAT, are configured to use FDM to transmit or receive the communications of the first RAT on the UL carrier or the DL carrier concurrently with transmitting or receiving the communications of the second RAT.

22. The UE of claim 21, wherein the one or more processors, to multiplex the communications of the first RAT and the communications of the second RAT, are configured to use FDM to transmit the communications of the first RAT on the UL carrier or the DL carrier concurrently with receiving the communications of the first RAT.

23. A user equipment (UE) for wireless communication, comprising:
a memory; and
one or more processors, coupled to the memory, configured to:
receive a configuration that reallocates, to a first radio access technology (RAT), uplink (UL) resources or downlink (DL) resources reserved for a second RAT on an UL carrier or a DL carrier for the second RAT; and
multiplex, based at least in part on the configuration, communications of the first RAT and communications of the second RAT in a shared spectrum using frequency division multiplexing (FDM), time division multiplexing (TDM), spatial division multiplexing (SDM), subband full duplexing, in-band full duplexing, or a combination thereof.

24. The UE of claim 23, wherein the one or more processors, to receive the configuration, are configured to receive the configuration via system information, a medium access control (MAC) control element (CE), or a radio resource control (RRC), message, and wherein the configuration is semi-static.

25. The UE of claim 23, wherein the one or more processors, to reallocate UL resources or DL resources to the first RAT, are configured to reallocate UL resources or DL resources to the first RAT via FDM, TDM, SDM, subband full duplexing, in-band full duplexing, or a combination thereof.

26. The UE of claim 23, wherein the one or more processors, to reallocate UL resources or DL resources to the first RAT, are configured to reallocate UL resources or DL resources to the first RAT via rate matching.

27. The UE of claim 23, wherein the one or more processors, to reallocate UL resources or DL resources to the first RAT, are configured to reallocate UL resources or DL resources to the first RAT in association with carrier aggregation or dual connectivity, and wherein transmit or receive antennas of the UE are shared between the first and the second RAT.

28. The UE of claim 23, wherein the one or more processors, to reallocate UL resources or DL resources to the first RAT, are configured to reallocate UL resources or DL resources to the first RAT in radio resources of one or more of a frequency division duplex carrier for the second RAT or a time division duplex carrier for the second RAT.
